(19) United States
(12) Patent Application Publication
(10) Pub. No.: US 2018/0236370 A1
(43) Pub. Date: Aug. 23, 2018

(54) Inflatable Obstacle Course Equipment

(71) Applicant: Jacqueline C. Nadler, Chagrin Falls, OH (US)

(72) Inventor: Jacqueline C. Nadler, Chagrin Falls, OH (US)

(21) Appl. No.: 15/751,930

(22) PCT Filed: Aug. 12, 2016
(86) PCT No.: PCT/US2016/046754

§ 371 Date: Feb. 12, 2018

Related U.S. Application Data
(60) Provisional application No. 62/299,082, filed on Feb. 24, 2016.
(60) Provisional application No. 62/205,233, filed on Aug. 14, 2015.

(51) Int. Cl. A63K 3/04; A63B 17/04; A01K 15/02

(52) U.S. Cl. CPC A63K 3/046; A63B 2225/62; A01K 15/027; A63B 17/04

(57) ABSTRACT

Inflatable devices that can be used as training equipment, and a method for forming an obstacle course from inflatable equipment.

The present invention claims priority to U.S. Provisional Application Ser. No. 62/205,233, filed on Aug. 14, 2015 and U.S. Provisional Application Ser. No. 62/299,082, filed on Feb. 24, 2016, which are both fully incorporated herein.

The present invention is directed to inflatable devices, particularly to an inflatable device that can be used as horse training equipment, and more particularly to inflatable horse course equipment that can be used in the training of horses and/or during horse competitions. Although the inflatable horse course equipment of the present invention described herein is discussed with particular reference to for use with horses, is can be appreciated that the inflatable horse course equipment can also be used for other types of animals (e.g., pony, cats, dogs, etc.) and/or for other types of activities (e.g., motor cross, bike competitions, etc.).

### BACKGROUND OF THE INVENTION

Horse course equipment is used to train horses to jump over obstacles and to traverse various types of course paths. The building, moving, maintaining and storing of such horse course equipment requires extensive amounts of space and is very time consuming, expensive, and labor intensive to set up and disassemble. The horse course equipment is typically made of heavy materials, such as wood materials and is thus difficult to assemble, difficult to move, difficult to maintain, and can injure a person or horse if such person or horse falls on or otherwise impacts the horse course equipment. Another disadvantage of traditional horse course equipment is that it must typically be stored on grass or other outdoor course ground, thus is prone to deterioration over time. Additionally, equestrian jump standards, also typically made out of heavy wood materials, usually need to be painted and/or protected to maintain the life of the equipment. Horse course equipment can also include plants or artificial plants incorporated into the equipment which can be expensive and difficult to maintain. Many of horse show jumping participants are women and equestrian equipment is generally cumbersome and wears quickly in the elements.

In view of the current state of equestrian course equipment, it would be advantageous to develop horse course equipment which is lightweight, easy to move, easy to clean, lower cost, low maintenance, uncomplicated to set up and take down, minimizes storage space, reduces potential injury to a horse and/or to a rider, reduces repetitive motion injuries to ground staff or trainer, which can enhance the willingness of the trainers to set larger, more elaborate/interesting courses to help both a rider and/or a horse to advance, and optionally desensitize the horse, which includes various jump styles that can be easily and conveniently changed by a trainer to accommodate a student's and/or horse's needs, and/or which can prevent rotational falls and/or injury to a horse and/or rider.

It would also be advantageous to develop horse course equipment that maintain its position in a desired location during use, but is easy to move when required. Most venues such as jumping barns share the area with classes that do and do not include jumps. Prior art horse jumping equipment is difficult to remove so that the two different types of classes can be used at the same venue.

In view of the current state of equestrian course equipment, it would also be advantageous to provide horse course equipment which is designed to free riders, barn owners, ground crew, and/or trainers from moving heavy horse course equipment, repainting and/or replacing weathered components of horse course equipment, and/or storing large pieces of horse course equipment and training devices.

### SUMMARY OF THE INVENTION

The present invention relates to inflatable devices which can be adapted and designed as inflatable horse course equipment which can be used as a horse course training device to train horses and/or riders, and/or which can be used during horse competitions. Although the inflatable horse course equipment of the present invention described herein with particular reference for used with horses, it will be appreciated that the inflatable horse course equipment of method of use in accordance with the present invention can also be used for other types of animals, such as, for example, ponies, cats, dogs, etc. It can also be appreciated that the inflatable horse course equipment of the present invention can be used for other activities, such as training athletes in sports, for example, motor cross, bike competitions, etc. Such additional uses are contemplated by the present invention.

The present invention is directed to inflatable devices as horse course equipment and method of use to enable individuals to have fun learning to ride horses and to test their skills. The portability of the inflatable horse course equipment allows the structures to be temporarily and/or permanently set up in and outside barns, houses, farms, or other locations.

In one non-limiting aspect of the present invention, the inflatable horse course equipment can be formed in one or more structures and/or components that symbolize traditional horse course equipment. Non-limiting configurations of such structures can include, but are not limited to, an inflatable horse jump, inflatable standards, inflatable covers, exchangeable covers, interchangeable covers, fillers, etc. The inflatable horse course equipment of the present invention can be formed in a variety of sizes, shapes, materials and colors.

In another and/or alternative non-limiting aspect of the invention, the inflatable horse course equipment can be in the form of inflatable jumps, covers, fillers, borders (e.g., dressage and separation, arena border, etc.), barrels, jump pole covers, jump tape, and the like. Other and/or alternative non-limiting examples of horse course equipment in accordance with another and/or alternative non-limiting aspect of the present invention includes, but is not limited to, round pens, inflatable round pens, stalls, inflatable stalls, holding pens, inflatable holding pens, driving obstacles, inflatable driving obstacles, desensitization obstacles, inflatable desensitization obstacles, cups, inflatable cups, cavities, inflatable cavities, ledges, inflatable ledges, etc. Still other and/or alternative non-limiting examples of horse course equipment in accordance with the present invention includes: standards, inflatable standards, covers, fillers, inflatable covers, pillars, inflatable pillars, columns, inflatable columns, roll tops, inflatable roll tops, round tops, inflatable round tops, V-cuts, inflatable V-cuts, bowl cuts, inflatable bowl cuts, coops, inflatable coops, flower boxes, inflatable flower boxes, walls, inflatable walls, themed fillers, inflatable themed fillers, inflatable borders for arenas, letters, inflatable letters, barrels, inflatable barrels, etc. As can be appreciated, other or additional shapes and/or types of inflatable and/or partially inflatable horse course equipment can be used in accordance with the present invention.

In another and/or alternative non-limiting aspect of the invention, the inflatable horse course equipment includes one or more hooks, rings, Velcro™ and/or connection arrangements for pole attachments, weight structure attachments, etc.; however, this is not required. Generally, the horse course equipment can be used singularly; however, this is not required. As can be appreciated, one or more components of the inflatable horse course equipment can be used together in horse jump systems and/or courses. Similarly, one or more components of the inflatable horse course equipment can be used in conjunction with existing horse jump systems and/or courses; however, this is not required.

In another and/or alternative non-limiting aspect of the present invention, the inflatable horse course equipment can include an inflatable roll top. The inflatable roll top can be formed from one or more pieces of material defining an internal cavity therein. In one non-limiting configuration, the inflatable roll top is formed of a plurality of separate pieces of material connected together (e.g., heat welded together at the seam, stitched, etc.); however, this is not required. As can be appreciated, when one or more pieces of material are used, any technique can be used to attach such one or more pieces of material together. In another and/or alternative non-limiting configuration, at least one surface of the inflatable roll top includes a cap and/or valve for the purpose of facilitating inflation of the inflatable roll top. The inflatable roll top is not limited in size, shape or material. In one non-limiting configuration, when inflated, the inflatable roll top has a generally cone-shaped cross-sectional structure with a rounded top surface however, this is not required. In another and/or alternative non-limiting configuration, at least one surface can include one or more recesses and/or mounting surfaces configured to accommodate the attachment of one or more external structures (e.g., flower pots, flags, poles, etc.); however, this is not required.

In another and/or alternative non-limiting aspect of the present invention, the height of the inflatable roll top can be adjusted by adding one or more inflatable support structures configured to be positionable underneath the bottom portion of the inflatable roll top (i.e., attached to the bottom surface of the base portion of the inflatable roll top, etc.). Generally, the one or more inflatable support structures (when used) are sized to be about equal to the length and width of the bottom portion of the inflatable roll top and are typically configured to be square or rectangular in cross-sectional shape when inflated; however, this is not required. The one or more inflatable support structures (when used) can be 1) permanently or temporarily attached to the bottom portion of the inflatable roll top, and/or 2) easily and conveniently inflated and/or deflated to adjust the height of the inflatable roll top; however, this is not required. In non-limiting configurations where one or more inflatable support structure is used, the connection arrangement between 1) the inflatable support structure and inflatable roll top, and/or 2) the one or more inflatable support structures is non-limiting (e.g., Velcro™, tape, tether, straps, snaps, hooks, zipper, adhesive, etc.).

In another and/or alternative non-limiting configuration of the present invention, at least one surface of the one or more inflatable support structures (when used) include a cap and/or valve for the purpose of facilitating inflation of the one or more inflatable support structures. The inflatable roll top and/or the one or more inflatable support structures (when used) can include single or separate openings and/or valves that are used to inflate and/or deflate the inflatable roll top and/or the one or more inflatable support structures.

In another and/or alternative non-limiting aspect of the present invention, the inflatable roll top can be configured to include one or more structures used to secure the inflatable roll top in position when inflated; however, this is not required. As such, in one non-limiting configuration, the inflatable roll top can include one or more internal structures configured to add weight, such as, for example, an internal fluid bladder and/or sand or gravel bladder, for the purpose of at least partially weighing down a portion of the inflatable roll top to the ground; however, this is not required. In one non-limiting configuration, the one or more internal structures are configured to hold from about 0.5 pounds to about 200 pounds of material; however, this is not required. The one or more internal structures (when used) can be configured to be positionable at any position in the internal cavity of the inflatable structure; however, this is not required. The one or more internal cavities can include a separate valve or opening to enable the internal cavity to be filled or emptied independent of the inflation or deflation of the inflatable roll top; however, this is not required.

In another and/or alternative non-limiting configuration, the inflatable roll top can also or alternatively include one or more external structures configured to add weight, such as, for example, one or more weight structures (e.g., external and/or internal fluid bladders, external and/or internal sand or gravel bladder, etc.), and/or one or more pole sleeves configured to facilitate insertion of a bar or pole therethrough, thereby at least partially weighing down a portion of the inflatable roll top to the ground; however, this is not required. The one or more external structures can be designed to hold from about 0.01 pounds to about 600 pounds (and all values and ranges therebetween), more typically from about 0.2 pounds to about 500 pounds. In one non-limiting configuration, the one or more external structures (when used) can be configured to hold from about 0.5 pounds to about 200 pounds; however, this is not required. The one or more external structures and/or pole sleeves (when used) can extend from about 1% to about 100% of the length of the inflatable roll top and can be provided at or near any edge of the inflatable roll top; however, this is not required. In another and/or alternative non-limiting configuration, the one or more external structures can be configured to be removable from the inflatable structure; however, is not required. In one non-limiting configuration, the one or more external structures can be temporarily secured to an external portion of the inflatable structure (e.g., Velcro™, tape, tether, straps, snaps, hooks, zipper, adhesive, etc.); however, this is not required. In another and/or alternative non-limiting configuration, the one or more external structures can be configured to be removable from the inflatable structure; however, is not required. In another non-limiting configuration, the one or more external structures can be permanently secured to an external portion of the inflatable structure. As can be appreciated, the one or more external structures can extend partially or fully around the inflatable structure; however, this is not required. In another and/or alternative non-limiting aspect of the present invention, the inflatable roll top can be configured to include one or more connection arrangements to facilitate in the attachment of the inflatable roll top to the ground; however, this is not required. The type of connection arrangement (when used) is non-limiting. In one non-limiting configuration, the inflatable roll top includes a plurality of straps and/or loops extending from an edge of the inflatable roll top designed to facilitate insertion of a stake and/or hook therethrough so as to hold the inflatable roll top in position against the ground surface; however, this is not required.

In another and/or alternative non-limiting aspect of the present invention, the inflatable roll top can include a removable cover; however, this is not required. The removable cover (when used) can be configured to at least partially attach to a portion of the inflatable roll top for the purpose of 1) displaying particular information printed on said removable cover, 2) covering at least a portion of the inflatable roll top for the purpose of protecting the material of the inflatable roll top; and/or 3) creating a certain design or look in the inflatable roll top; however, this is not required. The removable connection is non-limiting (e.g., Velcro™, tape, tether, straps, snaps, hooks, zipper, adhesive, etc.). In one non-limiting configuration, the removable cover can be used to display information (e.g., advertisement, names, event information, numbers, etc.); however, this is not required.

The inflatable roll top is not limited in height and/or size. In one non-limiting configuration, the height of the inflatable roll top can be from about 0.50 feet to about 6 feet (an all values and ranges therebetween), more typically from about 1 foot to about 4 feet, and more typically from about 2 feet to about 3 feet. In another and/or alternative non-limiting configuration, the width of the inflatable roll top can be from about ½ foot to about 20 feet (an all values and ranges therebetween), more typically from about 1 foot to about 16 feet, and more typically from about 4 feet to about 12 feet. In another and/or alternative non-limiting configuration, the length of the inflatable roll top can be from about ½ foot to about 6 feet (an all values and ranges therebetween), more typically from about 1 foot to about 4 feet, and more typically from about 2 feet to about 3 feet; however, this is not required. As can be appreciated, larger sizes can be used or smaller sizes for use as toys can be used.

In another and/or alternative non-limiting aspect of the present invention, the inflatable horse course equipment can include an inflatable horseshoe top. The inflatable horseshoe top can be formed from one or more components and/or pieces of material defining an internal cavity therein. In one non-limiting embodiment, the base structure of the inflatable horseshoe top can be formed from one or more of pieces of material that are connected together (e.g., heat welded together at the seams, stitched, etc.); however, this is not required. As can be appreciated, when one or more pieces of material are used, any technique can be used to attach such one or more pieces of material together. The shape of the material used to form the inflatable horseshoe top is non-limiting. In one non-limiting configuration, the shape of the base structure has a trapezoidal cross-sectional shape; however, this is not required. There is typically provided at least one internal cavity in the base structure. The inflatable horseshoe top can include first and second top structures. The size, shape and material of the first and second top structures are non-limiting. In one non-limiting configuration, the first and second top structures are arcuate and concave in shape. As such, the first and second top structure, when inflated and attached to the top portion of the base structure, can have a general shape and/or printing on at least one outside surface to convey an appearance of a horseshoe however, this is not required. In one non-limiting configuration, the internal cavity of the base structure is continuous with the internal cavity of the first top structure and the internal cavity of the second top structure; however, this is not required. In one non-limiting configuration, at least the majority of the inflatable horseshoe top is inflatable; however, this is not required. In another and/or alternative non-limiting configuration, at least one surface of the inflatable horseshoe top includes a cap and/or valve for the purpose of facilitating inflation of the inflatable horseshow top that is independent of the base structure; however, this is not required. The first and second top structures can be removably (e.g., Velcro™, tape, tether, straps, snaps, hooks, zipper, adhesive, etc.) or irremovably connected to the base structure.

In another and/or alternative non-limiting configuration, the height and/or configuration of the inflatable horseshoe top can be adjusted or changed by adding or removing one or more removable support structures wherein one or more removable support structures can be optionally configured to be inflatable; however, this is not required. The one or more removable support structures (when used) are configured to be positionable above and/or below the base structure of the inflatable horseshoe top; however, this is not required. In one non-limiting configuration, the removable support structure is configured to be positioned on the top surface of the base structure and further configured to extend partially or fully between the first and second top structures; however, this is not required. When one or more removable support structures are positioned under the base of the inflatable horseshoe top, such inflatable structures are the same or similar in function as the inflatable support structures described above with respect to the inflatable roll top. The one or more removable support structures (when used) can be 1) permanently or temporarily attached to the base structure of the inflatable horseshoe top, and/or 2) easily and conveniently inflated and/or deflated to adjust the height to the inflatable horseshoe top; however, this is not required. In non-limiting configurations where one or more removable support structures are used, the connection arrangement between 1) the one or more removable structures and the base structure, 2) the one or more removable structures and the first and second top structures, and/or 3) the one or more removable structures, is non-limiting (e.g., Velcro™, tape, tether, straps, snaps, hooks, zipper, adhesive, etc.). In another and/or alternative non-limiting configuration of the present invention, at least one surface of the one or more removable structures (when used) include a cap and/or valve for the purpose of facilitating inflation of the one or more removable structures; however, this is not required.

In another and/or alternative non-limiting aspect of the present invention, when the inflatable horseshoe top is inflated, the inflatable horseshoe top has a generally upward-facing, horseshoe-shaped structure or appearance; however, this is not required. In one non-limiting configuration, at least one surface can include one or more recesses and/or mounting surfaces configured to accommodate the attachment of one or more external structures (e.g., flower pots, flags, poles, etc.); however, this is not required.

In another and/or alternative non-limiting aspect of the present invention, the inflatable horseshoe top can be designed to include one or more structures designed to secure the inflatable horseshoe top in position when inflated; however, this is not required. Such structures can be the same or similar to the structures discussed above with regard to the inflatable roll top (e.g., one or more internal structures, one or more external structures, one or more pole sleeves, one or more connection arrangements, etc.). In another and/or alternative non-limiting aspect of the present invention, the inflatable horseshoe top can include a removable cover and can have similar features as discussed above with regard to the inflatable roll top; however, this is not required.

The inflatable horseshoe top is not limited in size. In one non-limiting configuration, the height of the inflatable horseshoe top can be from about 0.50 feet to about 20 feet (an all values and ranges therebetween), more typically from about 1 foot to about 10 feet, and more typically from about 2 feet to about 8 feet. In another and/or alternative non-limiting configuration, the width of the inflatable horseshoe top can be from about ½ foot to about 20 feet (an all values and ranges therebetween), more typically from about 1 foot to about 16 feet, and more typically from about 4 feet to about 12 feet. In another and/or alternative non-limiting configuration, the length of the inflatable horseshoe top can be from about ½ foot to about 6 feet (an all values and ranges therebetween), more typically from about 1 foot to about 4 feet, and more typically from about 2 feet to about 3 feet; however, this is not required. As can be appreciated, larger sizes can be used or smaller sizes for use as toys can be used.

In another and/or alternative non-limiting aspect of the present invention, the inflatable horse course equipment can be in the form of an inflatable horse jump that includes one or more poles. The inflatable horse jump can be formed from one or more pieces of material connected together; however, this is not required. The inflatable horse jump can be partially or fully inflatable. At least one surface of the inflatable horse jump includes a cap and/or valve for the purpose of facilitating inflation of the inflatable horse jump; however, this is not required. The size, shape and material of the inflatable horse jump are non-limiting.

In one non-limiting configuration, the inflatable horse jump can have a generally U-shape, V-shape, or C-shape configuration having a first and second end portion of greater height than a middle portion of the inflatable horse jump. The size and shape of the first and second end portion of the inflatable horse jump is non-limiting. Similarly, the size and shape of the middle portion of the inflatable horse jump is non-limiting. Non-limiting examples of such inflatable horse jumps can include, but are not limited to, inflatable square end horse jumps, inflatable round end horse jumps, inflatable bowl top horse jumps, inflatable round top horse jumps, inflatable V-cut horse jumps, etc.

In another and/or alternative non-limiting configuration, the height of the inflatable horse jump can be adjusted by adding or removing one or more removable structures, wherein one or more removable structures can be optionally configured to be inflatable; however, this is not required. The one or more removable structures (when used) are configured to be positionable below the base of the inflatable horse jump; however, this is not required. These removable structures (when used) have the same or similar features to the removable structures described with respect to the inflatable horseshoe top and the inflatable roll top; however, this is not required.

In another and/or alternative non-limiting aspect of the present invention, the inflatable horse jump is generally configured to include one or more cups configured to accommodate the temporary and/or permanent holding of a pole; however, this is not required. In one non-limiting configuration, an inner surface (i.e., the surface of the first end portion facing the second end portion, the surface of the second end portion facing the first end portion, etc.) of the first and second end portions can have one or more cups; however, this is not required. The cups (when used) can be configured to be inflatable and joined to the inflatable horse jump; however, this is not required. As such, when the inflatable horse jump is inflated, the one or more cups are also inflated; however, this is not required. As can be appreciated, one or more of the cups can be formed of a material that is not inflatable; however, this is not required. The one or more cups (when used) are typically provided at or near the top end (i.e., the end away from ground level) of the inflatable horse jump; however, this is not required. As such, the one or more cups can be configured to hold the pole in a substantially horizontal orientation (i.e., parallel to the ground); however, this is not required. As can be appreciated, the one or more cups can hold the pole in other or alternative orientations. As can be appreciated, a plurality of cups can be used so that a plurality of poles can be supported by the inflatable horse jump and/or one or more of the poles can be adjusted in height on the inflatable horse jump. The size, shape and material of the one or more cups are non-limiting. As such, the one or more cups can be designed to accommodate various types of poles (e.g., metal poles, PVC poles, plastic poles, composite poles, wood poles, inflatable poles, etc.). The shape of the cavity of the cups is non-limiting (e.g., C-shape, V-shape, U-shape, etc.). The surface of the cups can optionally include one or more ribs, recesses, etc. to facilitate in maintaining a pole in the cup; however, this is not required.

In another and/or alternative non-limiting aspect of the present invention, the inflatable horse jump can be designed to include one or more structures designed to secure the inflatable horse jump in position when inflated; however, this is not required. Such structures can be the same or similar to the structures discussed above with regard to the inflatable roll top and inflatable horseshoe top (e.g., one or more internal structures, one or more external structures, one or more pole sleeves, one or more connection arrangements, etc.). In another and/or alternative non-limiting aspect of the present invention, the inflatable horse jump can include a removable cover and can have similar features as discussed above with regard to the inflatable roll top and inflatable horseshoe top; however, this is not required.

In another and/or alternative non-limiting aspect of the present invention, at least one surface of the inflatable horse jump can include one or more recesses and/or mounting surfaces designed to accommodate the attachment of one or more external structures (e.g., flower pots, flags, poles, etc.); however, this is not required.

The inflatable horse jump is not limited in size. Generally, the size of the inflatable horse jump is pre-determined and dependent on the shape and size of the material used to form the inflatable horse jump; however, this is not required. In one non-limiting configuration, the height of the inflatable horse jump can be from about 0.50 feet to about 6 feet (an all values and ranges therebetween), more typically from about 1 foot to about 4 feet, and more typically from about 2 feet to about 3 feet. In another and/or alternative non-limiting configuration, the width of the inflatable horse jump can be from about ½ foot to about 20 feet (an all values and ranges therebetween), more typically from about 1 foot to about 16 feet, and more typically from about 4 feet to about 12 feet. In another and/or alternative non-limiting configuration, the length of the inflatable horse jump can be from about ½ foot to about 6 feet (an all values and ranges therebetween), more typically from about 1 foot to about 4 feet, and more typically from about 2 feet to about 3 feet; however, this is not required. As can be appreciated, larger sizes can be used or smaller sizes for use as toys can be used.

In another and/or alternative non-limiting aspect of the present invention, the inflatable horse course equipment can include an inflatable angular top. The inflatable angular top can be formed from one or more pieces of material defining an internal cavity therein. In one non-limiting configuration, the inflatable angular top is formed of a plurality of pieces connected together at the seams; however, this is not required. As can be appreciated, when one or more pieces of material are used, any technique can be used to attach such one or more pieces of material together. The shape of the material used to form the inflatable angular top is non-limiting. In one non-limiting configuration, the cross-section shape of the inflatable angular top is generally triangular-shaped; however, this is not required. As can be appreciated, the inflatable angular top can have other and/or alternative shapes. In one non-limiting configuration, at least the majority of the inflatable angular top is inflatable; however, this is not required. In another and/or alternative non-limiting configuration, at least one surface of the inflatable angular top includes a cap and/or valve for the purpose of facilitating inflation of the inflatable angular top. The inflatable angular top is not limited in size, shape or material. In another and/or alternative non-limiting configuration, at least one surface can include one or more recesses and/or mounting surfaces designed to accommodate the attachment of one or more external structures (e.g., flower pots, flags, poles, etc.); however, this is not required.

In another and/or alternative non-limiting configuration, the height of the inflatable angular top can be adjusted by adding or removing one or more removable structures, wherein one or more removable structures can be optionally configured to be inflatable; however, this is not required. The one or more removable structures (when used) are configured to be positionable below the base of the inflatable angular top; however, this is not required. These removable structures (when used) have the same or similar features to the removable structures described with respect to the inflatable horseshoe top and the inflatable roll top; however, this is not required.

In another and/or alternative non-limiting aspect of the present invention, the inflatable angular top can be designed to include one or more structures designed to secure the inflatable angular top in position when inflated; however, this is not required. Such structures can be the same or similar to the structures discussed above with regard to the inflatable roll top and inflatable horseshoe top (e.g., one or more internal structures, one or more external structures, one or more pole sleeves, one or more connection arrangements, etc.). In another and/or alternative non-limiting aspect of the present invention, the inflatable angular top can include a removable cover and can have similar features as discussed above with regard to the inflatable roll top and inflatable horseshoe top; however, this is not required.

The inflatable angular top is not limited in size. In one non-limiting configuration, the height of the inflatable angular top can be from about 0.50 feet to about 6 feet (an all values and ranges therebetween), more typically from about 1 foot to about 4 feet, and more typically from about 2 feet to about 3 feet. In another and/or alternative non-limiting configuration, the width of the inflatable angular top can be from about ½ foot to about 20 feet (an all values and ranges therebetween), more typically from about 1 foot to about 16 feet, and more typically from about 4 feet to about 12 feet. In another and/or alternative non-limiting configuration, the length of the inflatable angular top can be from about ½ foot to about 6 feet (an all values and ranges therebetween), more typically from about 1 foot to about 4 feet, and more typically from about 2 feet to about 3 feet; however, this is not required. As can be appreciated, larger sizes can be used or smaller sizes for use as toys can be used.

In another and/or alternative non-limiting aspect of the present invention, the inflatable horse course equipment can include an inflatable horse jump having one or more inflatable standards. As can be appreciated, the one or more inflatable standards can be convertible from standard to fillers by changing the orientation and/or positioning of the standard (e.g., standing upright, laying on the side, etc.); however, this is not required. The inflatable standards can be formed from one or more pieces of material connected together at the seams; however, this is not required. As can be appreciated, any technique (e.g., heat welding, stitching, etc.) can be used to attach the one or more pieces of material together. The inflatable standard can be partially or fully inflatable. In one non-limiting configuration, at least the majority of the inflatable standard is inflatable; however, this is not required. In another and/or alternative non-limiting configuration, at least one surface of the inflatable standard includes a cap and/or valve for the purpose of facilitating inflation of the inflatable standard; however, this is not required. The size, shape and material of the inflatable standard are non-limiting. In one non-limiting configuration, the cross-sectional shape of the inflatable standard is square; however, other or alternative shapes can be used (e.g., rectangular, oval, circular, triangular, polygonal, etc.).

In another and/or alternative non-limiting aspect of the present invention, the inflatable standard is designed to include one or more cups configured to accommodate the temporary and/or permanent holding of a pole; however, this is not required. In one non-limiting configuration, two inflatable standards are used to hold a pole; however, this is not required. In such a configuration, a first surface (e.g., the surface of the first inflatable standard facing the second inflatable standard) of the first inflatable standard, and a first surface (e.g., the surface of the second inflatable standard facing the first inflatable standard) of the second inflatable standard can have one or more cups; however, this is not required. The cups (when used) can be configured to be inflatable and/or deflatable and joined to the inflatable standard during manufacturing; however, this is not required. As such, when the first and/or second inflatable standard is inflated, the one or more cups are also inflated; however, this is not required. As can be appreciated, the one or more cups can be configured to not be inflatable and/or deflatable. The one or more cups (when used) are typically provided at or near the top end (i.e., the end away from ground level) of the inflatable standard; however, this is not required. As such, the one or more cups can be designed to hold the pole in a substantially horizontal orientation (i.e. parallel to the ground); however, this is not required. As can be appreciated, the one or more cups can hold the pole in other or alternative orientations. The size, shape and material of the one or more cups are non-limiting. As such, the one or more cups can be designed to accommodate various types of poles (e.g., metal poles, PVC poles, plastic poles, composite poles, wood poles, inflatable poles, etc.). The surface of the cups can optionally include one or more ribs, recesses, etc. to facilitate in maintaining a pole on the cup; however, this is not required.

In another and/or alternative non-limiting aspect of the present invention, the height of the inflatable standard can be adjusted by adding one or more removable inflatable structures to the top and/or bottom of the inflatable standard. These removable structures (when used) have the same or similar features to the removable structures described with respect to the inflatable horseshoe top and the inflatable roll top; however, this is not required.

In another and/or alternative non-limiting aspect of the present invention, the inflatable standard can be designed to include one or more structures designed to secure the inflatable standard in position when inflated; however, this is not required. Such structures can be the same or similar to the structures discussed above with regard to the inflatable roll top and inflatable horseshoe top (e.g., one or more internal structures, one or more external structures, one or more pole sleeves, one or more connection arrangements, etc.). In another and/or alternative non-limiting aspect of the present invention, the inflatable standard can include a removable cover and can have similar features as discussed above with regard to the inflatable roll top and inflatable horseshoe top; however, this is not required.

In another and/or alternative non-limiting aspect of the present invention, at least one surface of the inflatable standard can include one or more recesses and/or mounting surfaces designed to accommodate the attachment of one or more external structures (e.g., flower pots, flags, poles, etc.); however, this is not required.

The inflatable standard is not limited in size. Generally, the size of the inflatable standard is pre-determined and dependent on the shape and size of the material used to form the inflatable standard; however, this is not required. In one non-limiting configuration, the height of the inflatable standard can be from about 0.50 feet to about 6 feet (an all values and ranges therebetween), more typically from about 1 foot to about 4 feet, and more typically from about 2 feet to about 3 feet. In another and/or alternative non-limiting configuration, the width of the inflatable standard can be from about ½ foot to about 20 feet (an all values and ranges therebetween), more typically from about 1 foot to about 16 feet, and more typically from about 4 feet to about 12 feet. In another and/or alternative non-limiting configuration, the length of the inflatable standard can be from about ½ foot to about 6 feet (an all values and ranges therebetween), more typically from about 1 foot to about 4 feet, and more typically from about 2 feet to about 3 feet; however, this is not required. As can be appreciated, larger sizes can be used or smaller sizes for use as toys can be used.

In another and/or alternative non-limiting aspect of the present invention, one or more fillers can be positioned between two inflatable standards. The fillers can be inflatable; however, this is not required. The size and shape of the one or more fillers is non-limiting. Non-limiting examples of filler shapes can include, but is not limited to: blocks, cylinders, prisms, cuboid, cube, share based pyramid, cone, triangular prism, sphere, etc. The one or more fillers can be configured to be connectable together and/or to an adjacently positioned inflatable standard; however, this is not required. When the fillers are configured to be releaseable connectable, Velcro™, tape, tether, straps, snaps, hooks, zipper, adhesive, etc. can be used. The one or more fillers can be designed to include one or more structures designed to secure the fillers in position; however, this is not required. Such structures can be the same or similar to the structures discussed above with regard to the inflatable roll top and inflatable horseshoe top (e.g., one or more internal structures, one or more external structures, one or more pole sleeves, one or more connection arrangements, etc.). In another and/or alternative non-limiting aspect of the present invention, the one or more fillers can include a removable cover and can have similar features as discussed above with regard to the inflatable roll top and inflatable horseshoe top; however, this is not required.

In another and/or alternative non-limiting aspect of the present invention, the inflatable horse course equipment can include an inflatable arena border. The inflatable arena border can be formed from one or more pieces of material connected together at the seams; however, this is not required. The inflatable arena border can be partially or fully inflatable. In one non-limiting configuration, at least the majority of the inflatable arena border is inflatable; however, this is not required. In another and/or alternative non-limiting configuration, at least one surface of the inflatable arena border includes a cap and/or valve for the purpose of facilitating inflation of the inflatable arena border; however, this is not required. The size, shape and material of the inflatable arena border are non-limiting. In one non-limiting configuration, the cross-sectional shape of the inflatable arena border is triangular; however, other or alternative shapes can be used (e.g., rectangular, oval, circular, square, polygonal, etc.).

In another and/or alternative non-limiting aspect of the present invention, the height of the inflatable arena border can be adjusted by adding one or more inflatable structures (e.g., letters, inflatable letters, etc.) to the top and/or bottom of the inflatable arena border. These removable structures (when used) have the same or similar features to the removable structures described with respect to the inflatable horseshoe top and the inflatable roll top; however, this is not required.

In another and/or alternative non-limiting aspect of the present invention, the inflatable arena border can be designed to include one or more structures designed to secure the inflatable arena border in position when inflated; however, this is not required. Such structures can be the same or similar to the structures discussed above with regard to the inflatable roll top and inflatable horseshoe top (e.g., one or more internal structures, one or more external structures, one or more pole sleeves, one or more connection arrangements, etc.). In another and/or alternative non-limiting aspect of the present invention, the inflatable arena border can include a removable cover and can have similar features as discussed above with regard to the inflatable roll top and inflatable horseshoe top; however, this is not required.

In another and/or alternative non-limiting aspect of the present invention, at least one surface of the inflatable arena border can include one or more recesses and/or mounting surfaces designed to accommodate the attachment of one or more external structures (e.g., letters, flower pots, flags, poles, etc.); however, this is not required.

The inflatable arena border is not limited in size. Generally, the size of the inflatable arena border is pre-determined and dependent on the shape and size of the material used to form the inflatable arena border; however, this is not required. In one non-limiting configuration, the height of the inflatable arena border can be from about 0.50 feet to about 6 feet (an all values and ranges therebetween), more typically from about 1 foot to about 4 feet, and more typically from about 2 feet to about 3 feet. In another and/or alternative non-limiting configuration, the width of the inflatable arena border can be from about ½ foot to about 20 feet (an all values and ranges therebetween), more typically from about 1 foot to about 16 feet, and more typically from about 4 feet to about 12 feet. In another and/or alternative non-limiting configuration, the length of the inflatable arena border can be from about ½ foot to about 6 fee (an all values and ranges therebetween), more typically from about 1 foot to about 4 feet, and more typically from about 2 feet to about 3 feet; however, this is not required. As can be appreciated, larger sizes can be used or smaller sizes for use as toys can be used.

In another and/or alternative non-limiting aspect of the present invention, the inflatable horse course equipment can be arranged and/or configured as an inflatable obstacle course. The inflatable obstacle course can include inflatable horse course equipment such as, but not limited to, standards, standard fillers, roll tops, coops, flower boxes, walls, themed fillers, borders for arenas, letters, borders, fences, barrels, brands, portable pens, cross-country jumps, driving obstacles, etc. The one or more inflatable devices used in the inflatable obstacle course can optionally be attached to 1) the ground, 2) ground poles, 3) water ballasts, and/or 4) other inflatable devices used in the inflatable obstacle course. As such, the one or more inflatable devices can be arranged and/or configured in the obstacle course so as to impede the movement of the horse and/or rider moving through the obstacle course; however, this is not required. The obstacle course can be inflated by blowers; however, this is not required. As such, the blowers can maintain the inflation of the obstacle course components as a horse and/or rider navigates the obstacles and moves from one end of the obstacle course to a second end of the obstacle course; however, this is not required. As can be appreciated, the obstacle course components can be inflated and the blower removed prior to use; however, this is not required. The shape and size of the one or more inflatable devices used in the obstacle course are non-limiting. The obstacle course arrangement (when used) can add to the fun and/or challenge of the experience.

In another and/or alternative non-limiting aspect of the present invention, the unique design of the inflatable horse course equipment of the present invention provides the rider, trainer, etc. with an ability to reconfigure the number and positions of the horse course equipment to create various horse course obstacles, training courses, borders, etc. without needing to completely deflate the horse course equipment.

In another and/or alternative non-limiting aspect of the invention, the horse course equipment includes an inflatable structure configured to cover an existing horse course equipment component, such as, for example, existing horse jump poles, table tops, and/or non-movable cross-country obstacles; however, this is not required. The inflatable structure is generally configured to include one or more holes and/or passages through an interior of said inflatable structure. As such, the one or more holes and/or passages can have a first end at one end surface of the inflatable structure and a second end at a second end surface of the inflatable structure, thereby defining an internal cavity extending through the inflatable container from a first end to a second end thereof. In one non-limiting configuration, the hole and/or passage through the inflatable structure can be configured to accommodate the diameter of a horse jump pole; however, this is not required. The size of the hole and/or passage extending through the inflatable structure can be designed to engage with the jump pole and to hold the jump pole firmly in place; however, this is not required. As can be appreciated, the inflatable structure can be configured to be partially or fully wrapped about an existing structure (e.g., pole, post, etc.) and then zipped closed, tied about, strapped about, etc., the existing structure prior to, during and/or after be connected to the existing structure.

In another and/or alternative non-limiting aspect of the invention, the horse course equipment includes pole skins configured to protect wood poles, PVC poles, etc. The pole skins can include a single- or multi-layered material. Each layer can provide a unique function; however, this is not required. As can be appreciated, the one or more layers can provide the same or different functions. In one non-limiting configuration, the interior material is designed to provide internal protection to the pole which the pole skin protects. In another and/or alternative non-limiting configuration, the exterior material can be designed to display various types of information, drawings, and/or designs; however, this is not required. In another and/or alternative non-limiting configuration, the pole skin can be designed to be reversible so as to be able to display different types of information, drawings, and/or designs; however, this is not required. In another and/or alternative non-limiting aspect of the present invention, the pole skins can include one or more panels of material; however, this is not required. When two or more panels of material are used, each panel can be connected together, such as, for example, by a zipper, stitching, heat welding, etc. In one non-limiting configuration, at least a portion of the pole skin is designed to partially or fully surround and/or cover a pole; however, this is not required. In one specific non-limiting embodiment, the pole skins include a zipper for the purpose of securing two neighboring panels of material around a pole; however, this is not required. The zipper (when used) is not limited in size, shape, or material.

In another and/or alternative non-limiting aspect of the invention, the pole skin can be designed to cover separate poles, such as, for example, two poles arranged in a horse jump; however, this is not required. In another and/or alternative non-limiting aspect of the invention, the pole skin can be designed to cover three separate poles, such as, for example, three poles arranged in a horse jump; however, this is not required. In another and/or alternative non-limiting aspect of the invention, the pole skin can be designed to cover four separate poles, such as, for example, four poles arranged in a horse jump; however, this is not required. As such, the pole skin can be designed to accommodate horse jumps having any number of poles; however, this is not required.

In another and/or alternative non-limiting aspect of the invention, the material used to form the horse course equipment can be a non-rigid material, such as, for example, flexible plastic material; however, other or alternative materials can be used (e.g., composite material, etc.). In another and/or alternative non-limiting aspect of the invention, the horse course equipment can be formed from airtight materials and/or watertight materials, such as, for example airtight and/or watertight fabric. In one non-limiting configuration, the material used to form the inflatable horse course equipment is a high strength polyvinyl chloride (PVC) coated material; however, this is not required. In one specific non-limiting configuration, the material used to form the inflatable horse course equipment is a PVC fabric reinforced with a woven polyester material; however, it can be appreciated that other or additional materials can be used. Generally, at least one of the materials used to form the inflatable horse course equipment is a flexible material. When one or more types of material are used to form the horse course equipment, the materials can be connected by welding, adhesives, stitching, melted seams, etc. for the purpose of obtaining a desired shape; however, this is not required. In one non-limiting configuration, the horse course equipment is heat welded at the seams for optimal air holding ability; however, this is not required. Such connections are generally designed to be airtight and/or watertight connections; however, this is not required. One non-limiting advantage of using such materials in construction of the horse course equipment is that the horse course equipment can be designed to be absent sharp edges, thereby improving the overall safety of the horse course equipment for both horse and rider. In another and/or alternative non-limiting aspect of the invention, the inflatable horse course equipment is designed to deform as a result of any stresses, thereby providing increased safety to both horse and rider. The horse course equipment of the present invention is generally designed to be lightweight and tolerant to the outside elements while keeping its aesthetic appeal and makes for a softer landing if and/or when there is a fall; however, this is not required. Another and/or alternative non-limiting advantage of the horse course equipment of the present invention is that when the horse course equipment is being moved, inflated, deflated, etc., any damage caused to other equipment can be reduced and/or eliminated; however, this is not required. The horse course equipment of the present invention can optionally be made of materials to make the horse course equipment easier to clean and easier to maintain. In another and/or alternative non-limiting aspect of the present invention, the inflatable horse course equipment is able to withstand the pressure of at least 200 pounds of force contacting the equipment without the inflatable structure bursting, typically at least 500 pounds, more typically at least 1000 pounds, and still more typically at least 1,400 pounds; however, this is not required. As such, the inflatable horse course equipment of the present invention is extremely durable and stable.

In another and/or alternative non-limiting aspect of the invention, the materials used to form the horse course equipment can optionally include materials having one or more properties including: 1) flame retardant properties, 2) mildew resistance properties, and/or 3) ultraviolet light resistance properties. In another and/or alternative non-limiting aspect of the invention, the horse course equipment can be formed from biodegradable, bio-remediated materials, and/or renewable resource materials, etc.; however, this is not required. One non-limiting advantage of using such materials in construction of the horse course equipment is that such materials are often less detrimental to the environment than traditional horse course materials (e.g., plastics, heavy metals, etc.). The thickness of the material used to form the inflatable horse course equipment is non-limiting. In one non-limiting configuration, the thickness of the material used to form the inflatable horse course equipment can be from about 0.01 millimeters to about 100 millimeters (and all values and ranges therebetween), more typically from about 0.05 millimeters to about 25 millimeters, and more typically from about 0.10 millimeters to about 10 millimeters; however, this is not required. Generally, the thickness of the material used to form the horse course equipment is selected to be durable, have mechanical stress resistance from horses and/or riders, reduced weight and ease of use.

In another and/or alternative non-limiting aspect of the present invention, the inflatable horse course equipment is designed to be lightweight. In one non-limiting configuration, the weight of one non-limiting inflatable horse jump is from about 0.25 pounds to about 50 pounds (and all values and ranges therebetween), more typically from about 1 pounds to about 40 pounds, and more typically from about 2 pounds to about 30 pounds; however, this is not required. In one non-limiting configuration, the weight of an inflatable horse jump is about 60 pounds; however, this is not required. In another and/or alternative non-limiting configuration, the weight of one non-limiting cross country course is from about 1 pound to about 500 pounds (and all values and ranges therebetween).

In another and/or alternative non-limiting aspect of the present invention, the horse course equipment can include one or more covers which can be permanently or temporarily connected to all or a portion of one or more pieces of the horse course equipment. The covers (when used) are not limited in size, shape, material or color. In one non-limiting configuration, the covers include a printed material, such as, for example, ads, rider names, horse names, station numbers, etc. on said covers. In another and/or alternative non-limiting configuration, the covers can be designed to be exchangeable so as to customize one or more pieces of the horse course equipment; however, this is not required. One non-limiting advantage of the covers (when used) are that the covers can be used as a “quick fix,” or added to existing indoor and/or outdoor horse courses, thereby adding to the overall versatility of the inflatable horse course equipment; however, this is not required. The removable cover (when used) can be designed to at least partially attach to a portion of the inflatable square end horse jump for the purpose of 1) displaying particular information printed on said removable cover, and/or 2) covering at least a portion of the inflatable square end horse jump for the purpose of protecting the material of the inflatable square end horse jump; however, this is not required.

In another and/or alternative non-limiting aspect of the present invention, the horse course equipment can include an inflatable device designed to conceal and/or cover existing horse course equipment structures, such as, for example, non-aesthetically appealing structures (e.g., ragged poles, etc.). As such, the horse course equipment of the present invention can be used to add an improved and/or desired aesthetic appearance to existing horse course equipment, existing horse course structures, etc.; however, this is not required.

In another and/or alternative non-limiting aspect of the invention, the horse course equipment includes an air pump (e.g., electric air pump, battery-powered air pump, etc.) for the purpose of partially or fully inflating the inflatable structures of the horse course equipment. In another and/or alternative non-limiting aspect of the invention, the horse course equipment includes a fan assembly for the purpose of forcing air to flow into the inflatable structure. In one non-limiting configuration, the horse course equipment optionally includes a fan assembly for the purpose of continuously forcing air into the inflatable portion of the horse course equipment. In embodiments where the fan assembly continuously forces air into the inflatable structure, the material used to form the horse course equipment is typically made of least a partially permeable material such that air is forced into the main body of the horse course equipment and when such air has filled the main body, the excess air can permeate out through the at least partially permeable material; however, this is not required.

In another and/or alternative non-limiting aspect of the invention, the horse course equipment includes a valve and/or cap suitable for facilitating inflation and/or deflation of the inflatable horse course equipment; however, this is not required. In one non-limiting configuration, the valve cap is a double leak protection valve and cap combination. In another and/or alternative non-limiting aspect of the invention, the horse course equipment includes a valve and/or cap suitable for facilitating filling and/or emptying of the one or more bladders, sand or gravel sections, etc. of the horse course equipment; however, this is not required. In one non-limiting configuration, the valve and/or cap used for filling the horse course equipment with air is the same type as the valve and/or cap used to fill the horse course equipment one or more bladders, sand or gravel sections, etc.; however, this is not required.

In another and/or alternative non-limiting aspect of the invention, the horse course equipment is designed to be deflatable. As such, the amount of storage space required to store the horse course equipment is drastically reduced, especially when compared to traditional horse course equipment. In one non-limiting configuration, the horse course equipment can optionally be designed to include an emergency air release zipper for instant deflation; however, this is not required.

In another and/or alternative non-limiting aspect of the invention, the components of the horse course equipment (e.g., standards, standard fillers, pillars, circular and/or center columns, roll tops, round tops, V cuts, bowl cuts, coops, flower boxes, walls, themed fillers, borders for arenas, letters, borders fences, barrels, etc.) are designed to be easily and conveniently stored in a storage sack when deflated; however, this is not required. In one non-limiting configuration, a rolling waterproof bin with a telescoping handle can be used to hold the deflated components of the horse course equipment and/or one or more storage sacks containing said components of the horse course equipment; however, this is not required.

In another and/or alternative non-limiting aspect of the invention, there is provided a method for assembling the horse course equipment of the present invention, the method comprising one or more of the following steps: 1) removing the folded and/or rolled inflatable horse course equipment from a storage sack; 2) unfolding and/or unrolling the inflatable horse course equipment at a desired site; 3) inflating the inflatable horse course equipment with an air pump; 4) securing the inflatable horse course equipment in position by adding weights and/or securing ground stakes, poles, or the like; and/or 5) optionally filling the one or more internal bladders of the inflatable horse course equipment; however, this is not required. As can be appreciated, other or additional steps can be used.

In another and/or alternative non-limiting aspect of the invention, there is provided a method for assembling, using, and disassembling the horse course equipment of the present invention, the method comprising one or more of the following steps: 1) obtaining a deflated component of horse course equipment, said component having a desired overall size; 2) carrying the deflated component of the horse course equipment to a desired location to be set up; 3) selecting a ground area suitable for assembling the deflated component of the horse course equipment; 4) unrolling and/or unfolding the deflated component of horse course equipment on the selected ground area; 5) placing the bottom surface of the component of horse course equipment on the ground; 6) inflating the component of horse course equipment by attaching an air pump to the horse course equipment; 7) starting the air pump by plugging in the power cord and/or battery of said air pump; 8) allowing time for the horse course equipment component to inflate; 9) securing the horse course equipment component to the ground by attaching one or more anchors (e.g., weights, stakes, etc.); 10) benefitting from a quick and easy means of assembling the horse course equipment; 11) deflating the horse course equipment after use; 12) rolling and/or folding the deflated horse course equipment into a compact state; 13) placing the deflated, rolled and/or folded horse course equipment in a carrying and/or storage bag, storage bin or container, and 14) removing the deflated horse course equipment from the site.

In another and/or alternative non-limiting aspect of the invention, there is provided a method for assembling, using, and disassembling the horse course equipment of the present invention as an obstacle course, the method comprising one or more of the following steps: 1) obtaining a deflated component of horse course equipment, said component having a desired overall size; 2) carrying the deflated component of the horse course equipment to a desired location to be set up; 3) selecting a ground area suitable for assembling the deflated component of the horse course equipment; 4) unrolling and/or unfolding the deflated component of horse course equipment on the selected ground area; 5) placing the bottom surface of the component of horse course equipment on the ground; 6) arranging the desired combination of horse course equipment components to create an obstacle course and/or training course; 7) inflating the component of horse course equipment by attaching an air pump to the horse course equipment; 8) starting the air pump by plugging in the power cord and/or battery of said air pump; 9) allowing time for the horse course equipment component to inflate; 10) connecting desired horse course equipment components together; 11) securing the horse course equipment component to the ground by attaching one or more anchors (e.g., weights, stakes, etc.); 12) benefitting from a quick and easy means of assembling the horse course equipment; 13) deflating the horse course equipment after use; 14) rolling and/or folding the deflated horse course equipment into a compact state; 15) placing the deflated, rolled and/or folded horse course equipment in a carrying and/or storage bag, storage bin or container; 16) removing the deflated horse course equipment from the site; and/or 17) benefitting from a quick and easy means of removing said horse course equipment from said location.

In another and/or alternative non-limiting aspect of the invention, the horse course equipment can optionally include an internally attached lighting system which can be used for the purpose of providing illumination without external lighting. Generally, external lights can create shadows around horse course equipment causing horses and/or riders to misjudge course obstacles, thereby making for a more dangerous riding experience and environment. The internal lighting system (when used) of the horse course equipment alleviates this and other problems of traditional horse course equipment requiring external lighting.

Non-limiting advantages of the inflatable horse course equipment of the present invention can include, but are not limited to:

1) easy and convenient assembly due to the structures merely needing to be inflated;

2) improved safety because the material used to form the horse course equipment is designed to compress upon impact, thereby reducing potential injury to the horse and/or rider when the horse and/or rider impacts the inflatable horse course equipment;

3) easy and convenient disassembly because the primary structures merely need to be deflated, and can thereafter be placed in a carrying and/or storage bag or bin (e.g., rolling storage bin, etc.) or container;

4) the light weight of the inflatable horse course equipment is easy to move;

5) the compact design of the inflatable horse course equipment minimizes the need for extensive storage space;

6) quick and effortless cleaning;

7) the inflatable horse course equipment can be used without extra or added weight; and,

8) riders and/or horses of all levels (beginner-level, advanced-level, etc.) can benefit from using such inflatable horse course equipment.

One non-limiting objective of the present invention is to provide an at least partially inflatable device that can function as horse course equipment.

Another and/or alternative non-limiting objective of the present invention is to provide inflatable horse course equipment that can be used in the training of horses and/or during horse competitions.

Yet another and/or alternative non-limiting objective of the present invention is to provide inflatable horse course equipment that can be configured in many different configurations to provide horse obstacle courses and/or horse training courses of various combinations.

Still another and/or alternative non-limiting objective of the present invention is to provide inflatable horse course equipment that can be stored in small locations.

Still yet another and/or alternative non-limiting objective of the present invention is to provide a horse course that is at least partially or fully formed of inflatable horse course equipment.

Another and/or alternative non-limiting objective of the present invention is to provide a horse course that includes one or more inflatable device that can be easily assembled and dissembled.

Yet another and/or alternative non-limiting objective of the present invention is to provide inflatable horse course equipment for use in a horse training course that can reduce injury to a horse and/or rider.

Still another and/or alternative non-limiting objective of the present invention is to provide inflatable horse course equipment that improves safety and reduces potential injury to the horse and/or rider when the horse and/or rider impacts the inflatable horse course equipment.

Still yet another and/or alternative non-limiting objective of the present invention is to provide lightweight inflatable horse course equipment that is easy to set up, take down, and/or to move.

Another and/or alternative non-limiting objective of the present invention is to provide a compact design for inflatable horse course equipment that minimizes the need to extensive storage space.

Yet another and/or alternative non-limiting objective of the present invention is to provide inflatable horse course equipment that requires easier cleaning and maintenance.

Still another and/or alternative non-limiting objective of the present invention is to provide inflatable horse course equipment that can be used without extra or added weight.

Another and/or alternative non-limiting objective of the present invention is to provide inflatable horse course equipment absent nails, deteriorating materials, and/or sharp edges.

These and other objectives will become apparent to those skilled in the art upon reading and following the description taken together with the accompanied drawings.

### BRIEF DESCRIPTION OF THE DRAWINGS

Reference may now be made to the drawings which illustrate various non-limiting embodiments that the invention may take in physical form and in certain parts and arrangement of parts wherein:

FIG. 1 is a front perspective illustration of an inflatable roll top in accordance with one non-limiting aspect of the present invention;

FIG. 2 is a side plan view of the inflatable roll top of FIG. 1 which includes two inflatable support structures positioned under the inflatable roll top;

FIG. 3 is a front perspective illustration of an inflatable horseshoe top in accordance with another and/or alternative non-limiting aspect of the present invention;

FIG. 4 is a perspective illustration of the inflatable horseshoe top of FIG. 3 absent the removable support structure positioned between the arc-shaped inflatable structures.

FIG. 5 is a front perspective illustration of an inflatable square end horse jump in accordance with another and/or alternative non-limiting aspect of the present invention;

FIG. 6 is a front perspective illustration of an inflatable bowl cut horse jump in accordance with another and/or alternative non-limiting aspect of the present invention;

FIG. 7 is a front perspective illustration of an inflatable V-cut horse jump in accordance with another and/or alternative non-limiting aspect of the present invention;

FIG. 8 is a front perspective illustration of an inflatable cone top and two inflatable support structures positioned under the inflatable cone top in accordance with another and/or alternative non-limiting aspect of the present invention;

FIG. 9 is a front perspective illustration of an inflatable round top horse jump having a removable cover in accordance with another and/or alternative non-limiting aspect of the present invention;

FIG. 10 is a front perspective illustration of an inflatable horse jump in accordance with another and/or alternative non-limiting aspect of the present invention;

FIG. 11 is a front perspective illustration of an inflatable arena border in accordance with another and/or alternative non-limiting aspect of the present invention;

FIG. 12 is a front perspective illustration of a standard, filler, and horse jump which includes the use of inflatable equipment in accordance with another and/or alternative non-limiting aspect of the present invention;

FIG. 13 is a front perspective illustration of an inflatable pole cover in accordance with another and/or alternative non-limiting aspect of the present invention;

FIG. 14 is a front perspective illustration of an inflatable pole cover in accordance with another and/or alternative non-limiting aspect of the present invention;

FIG. 15 is a front perspective illustration of an inflatable pole cover in accordance with another and/or alternative non-limiting aspect of the present invention;

FIG. 16 is a cross-sectional illustration of inflatable pole cover taken along A-A of FIG. 15;

FIG. 17 is a front perspective illustration of a pole skin in accordance with another and/or alternative non-limiting aspect of the present invention;

FIG. 18 is a cross-sectional illustration of pole skin taken along B-B of FIG. 17;

FIG. 19 is a front perspective illustration of a inflation pump used to inflate inflatable horse course equipment in accordance with another and/or alternative non-limiting aspect of the present invention;

FIG. 20 is a top perspective illustration of an obstacle course incorporating various inflatable horse course equipment components in accordance with another and/or alternative non-limiting aspect of the present invention;

FIG. 21 is a flow chart that sets forth one non-limiting method for assembling, utilizing, and disassembling the inflatable horse course equipment in accordance with another and/or alternative non-limiting aspect of the present invention; and,

FIG. 22 is a front perspective illustration of an inflatable filler in accordance with another and/or alternative non-limiting aspect of the present invention.

### DETAILED DESCRIPTION OF THE NON-LIMITING EMBODIMENTS

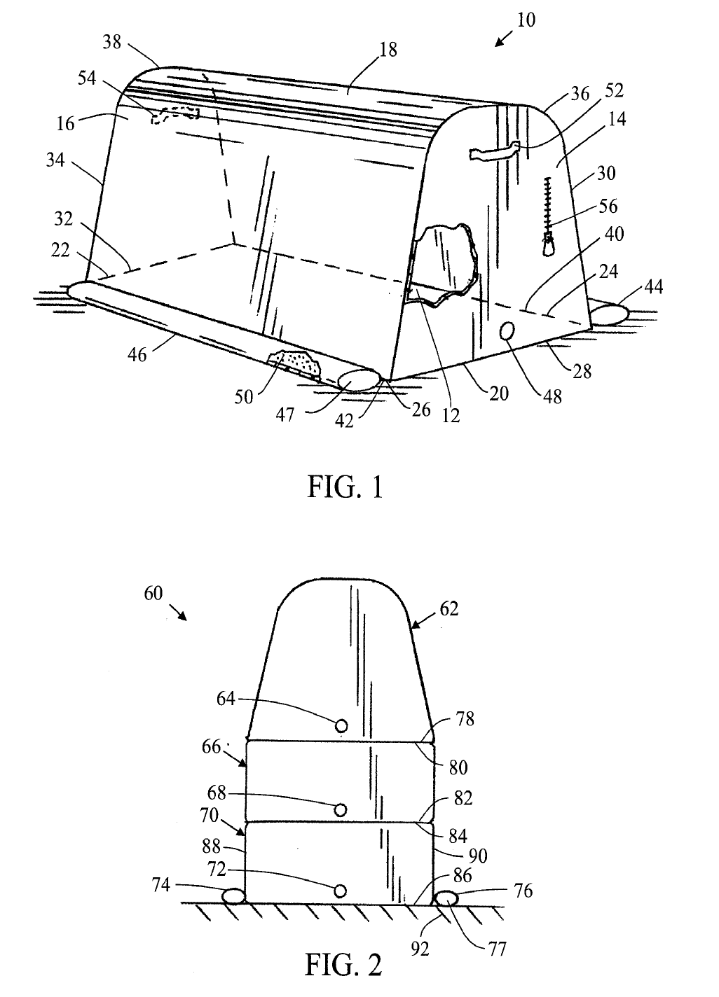

Referring now to the drawings, wherein the showings are for the purpose of illustrating at least one non-limiting embodiment of the invention only and not for the purpose of limiting the invention, FIGS. 1-20 and 22 illustrate various inflatable horse course equipment components in accordance with the present invention.

The present invention is directed to horse jumping obstacles that are partially or fully formed of inflatable structures, and to the creation of a horse jumping obstacle course that is partially or fully formed of inflatable structures. The components of the horse course equipment can include standards, standard fillers, roll tops, coops, flower boxes, walls, themed fillers, borders for arenas, letters, borders, fences, banks, brands, portable pens, cross-country jumps, and driving obstacles. It can be appreciated that any combination of such horse course equipment can be used to form a horse jumping obstacle course in accordance with the present invention.

Various non-limiting obstacles for use with horse jump are described with regard to FIGS. 1-20; however, it will be appreciated that many other obstacles that are partially or fully formed with inflatable structures can be created, and such obstacles are contemplated by this invention.

Referring now to FIG. 1, this is an illustration of a non-limiting inflatable roll top 10 in accordance with one non-limiting aspect of the present invention. The inflatable roll top 10 includes a base panel 12, a first side panel 14, a second side panel 16, and a top panel 18. Base panel 12 is illustrated as being generally rectangular in shape providing a first side edge 20, a second side edge 22, a first longitudinal edge 24, and a second longitudinal edge 26; however, it can be appreciated that other shapes can be used (e.g., square, polygonal, circular, oval, etc.). First side panel 14 is illustrated as being generally trapezoid in shape having a bottom edge 28 and an edge 30. Similarly, second side panel 16 is illustrated as being generally trapezoid in shape having a bottom edge 32 and an edge 34. The top portion of the first and second panels can have curved or rounded portions; however, this is not required. Top panel 18 is illustrated as being generally rectangular in shape providing a first side edge 36, a second side edge 38, a first longitudinal edge 40, and a second longitudinal edge 42. As illustrated in FIG. 1, first side edge 20 of base panel 12 can be connected to bottom edge 28 of first side panel 14. Similarly, second side edge 22 of base panel 12 can be connected to bottom edge 32 of second side panel 16. As further illustrated in FIG. 1, first side edge 36 of top panel 18 is connected to arcuate edge 30 of first side panel 14, second side edge 38 of top panel 18 is connected to arcuate edge 34 of second side panel 16, first longitudinal edge 40 of top portion 18 is connected to first longitudinal edge 24 of base panel 12, and second longitudinal edge 42 of top panel 18 is connected to second longitudinal edge 26 of base panel 12. As can be appreciated, top panel 18 and first and second side panels 14, 16 can be formed of a single piece of material. The panels 12, 14, 16, 18 can be connected together at or near the edges by heat welding, thereby providing an internal cavity; however, this is not required. As can be appreciated, other or additional types of connection arrangements can be used (e.g., stitching, tether, zippers, Velcro™, adhesive, tape, straps, snaps, hooks, etc.).

The material used to form of the inflatable roll top and any of the other inflatable structures described herein is a durable, flexible, bendable, and foldable material and is partially or fully impermeable to air and/or water. The material can be coated with a material that improves the air impermeability and/or water impermeability of the material; however, this is not required. The material can be a fiber reinforced polymer material; however, this is not required. The inflatable structures are generally designed to withstand impact forces of at least 200 pounds without causing damage to the inflatable structures, and can be designed to withstand impact forces of 1400 pounds or greater without causing damage to the inflatable structures. If the material used to form the inflatable structures is punctured or otherwise damaged, the material is generally designed to be easily patched via a heated seal, stitching, etc.

First side panel 14 is illustrated in FIG. 1 as having a valve and/or cap 48 in and/or covering an opening in the panel. Valve and/or cap 48 is generally designed to facilitate controlled inflation and/or controlled deflation of the inflatable roll top 10. Inflatable roll top 10 can be inflated by at least one air pump (see FIG. 19); however, this is not required. When inflated (i.e., when air is caused to move into the internal cavity of inflatable roll top 10), inflatable roll top 10 is caused to increase in height and volume until inflatable roll top 10 is fully inflated with air. As illustrated in FIG. 1, when inflated, first and second side panels 14, 16 extend approximately perpendicularly and upwardly from base panel 12. Similarly, top panel 18 is illustrated as extending from first longitudinal edge 24 to second longitudinal edge 26 of base panel 12, following the arcuate edges 30, 34 of first and second side panels 14, 16.

With continued reference to FIG. 1, inflatable roll top 10 optionally includes a weight structure in the form of a first weight structure 44 and/or a second weight structure 46. First weight structure 44 is illustrated as being connected along 1) first longitudinal edge 24 of base portion 12, and/or 2) first longitudinal edge 40 of top portion 18. Similarly, second weight structure 46 is illustrated as being connected at or near 1) second longitudinal edge 26 of base portion 12, and/or 2) second longitudinal edge 42 of top portion 18. The first and/or second weight structures (when used) can be permanently or releasably connected to the lower regions of the inflatable roll top.

As further illustrated in FIG. 1, first and second weight structures 44, 46 can include a weighting material 50, such as, for example, gravel, sand, liquid, gel, rod, pole, etc. First and second weight structures 44, 46 can have one or more open ends and/or valves and/or caps 47 designed to facilitate filling of the first and second weight structures with such weighted material 50; however, this is not required. The use of the weighting material is used to maintain the inflatable roll top in position and/or to inhibits or prevents the tipping of the inflatable roll top when contacted by a horse jumping over the inflatable roll top.

Although not shown, the interior of the inflatable roll top can be partially filled with weighted material prior to, during, and/or after the inflation of the inflatable roll top; however, this is not required. The valve and/or cap 48 can be used to insert and/or remove the weighted material from/into the interior cavity of the inflatable roll top. As also can be appreciated, a weighted structure can alternatively or additionally be positioned in the interior cavity of the inflatable roll top. If a weighted structure is optionally positioned in the interior cavity of the inflatable roll top, a valve and/or cap can be optionally positioned in at least one of the side panels to facilitate in the filling and/or unfilling of the weighted structure.

With continued reference to FIG. 1, first side panel 14 is illustrated as optionally including a handle 52. Similarly, second side panel 16 is illustrated as optionally including a handle 54. Handles 52, 54 can be designed to enable a user to easily and conveniently move the inflatable roll top 10 when in an inflated and/or deflated state; however, this is not required. As further illustrated in FIG. 1, first side panel 13 optionally includes an emergency air release zipper 56 designed to enable a user to rapidly deflate inflatable roll top 10 as needed, such as, for example, in case of an emergency; however, this is not required.

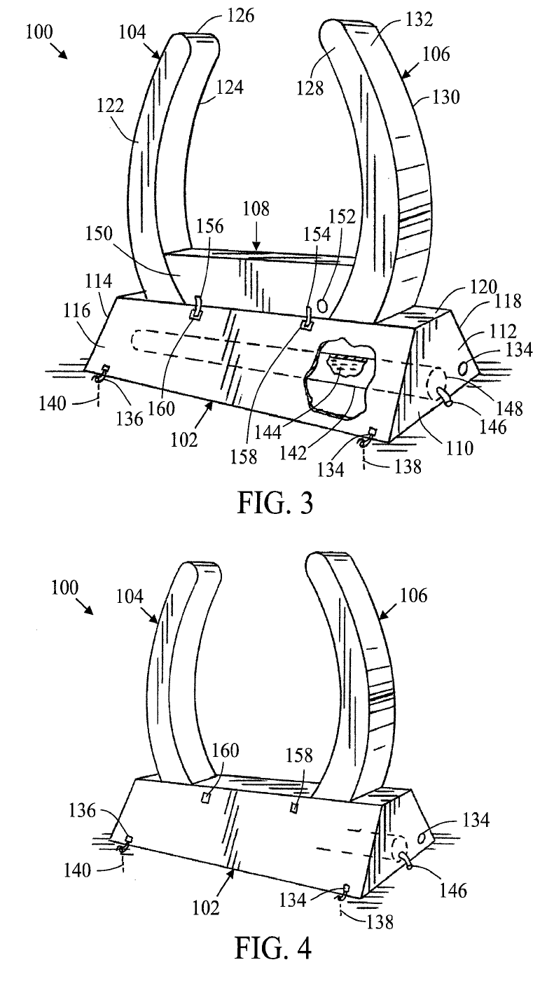

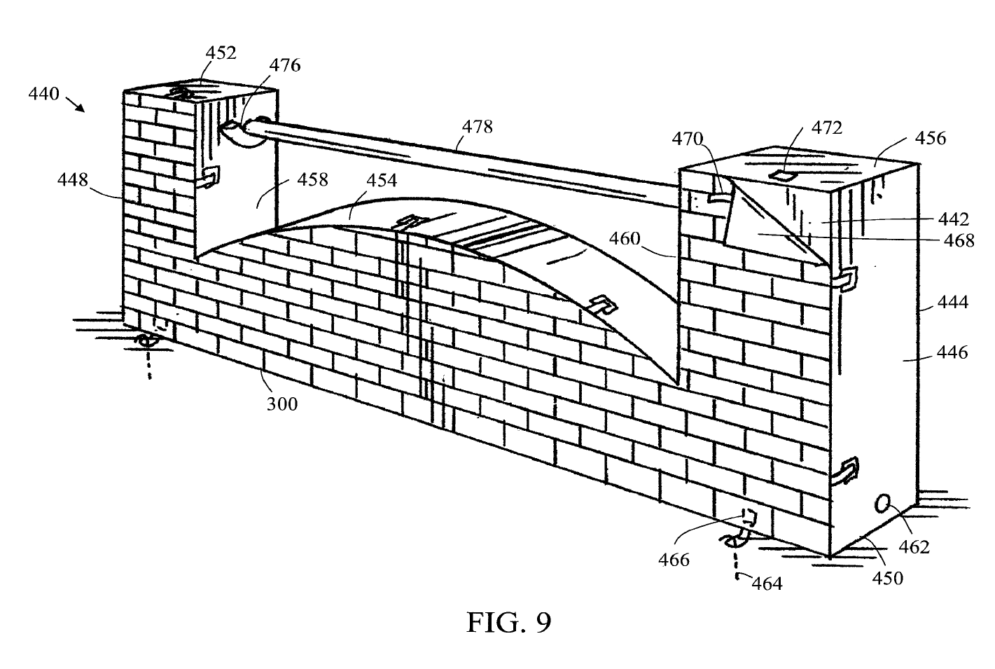

As can be appreciated, inflatable roll top 10 can include other or additional features, such as, for example, at least one connection arrangement (see FIGS. 3-4), a removeable cover (see FIG. 9), etc.

Referring now to FIG. 2, there is illustrated a side-view perspective view of an inflatable roll top 60 in accordance with another and/or alternative non-limiting aspect of the present invention. Inflatable roll top 60 is illustrated as including three separate inflatable structures: 1) an inflatable roll top 62 having a valve and/or cap 64 in and/or covering an opening in the roll top, 2) an inflatable support structure 66 having a valve and/or cap 68 in and/or covering an opening in the support structure, and 3) an inflatable support structure 70 having a valve and/or cap 72 in and/or covering an opening in the support structure; however, this is not required. Inflatable roll top 62 has a structure similar to inflatable roll top 10 of FIG. 1. Inflatable support structures 66 and 70 have generally the same shape; however, this is not required. The cross-sectional shape of the inflatable support structures is illustrated as being rectangular; however, other shapes can be used (e.g., square, polygonal, etc.). Generally, the top and bottom surfaces of the inflatable support structures are generally flat or planar when in the inflated state; however, this is not required. Generally, the top surface of the inflatable support structure that engages the bottom surface of inflatable roll top 62 has a size and shape that is generally the same or similar to the size and shape of the bottom of the inflatable roll top 62; however, this is not required. As can be appreciated, inflatable roll top 60 can include additional and/or alternative inflatable structures.

Inflatable roll top 62 is illustrated as providing at least a bottom surface 78 being planar and having a generally rectangular shape; however, other or alternative shapes can be used. Inflatable support structure 66 is illustrated as providing at least a top surface 80 being planar and having a generally rectangular shape, and a bottom surface 82 being planar and having a generally rectangular shape; however, other or alternative shapes can be used. Inflatable support structure 70 is illustrated as providing at least a top surface 84 being planar and having a generally rectangular shape, and a bottom surface 86 being planar and having a generally rectangular shape; however, other or alternative shapes can be used. Generally, the size and shape of bottom portion 78 of inflatable roll top 62 is designed to be same and/or similar to the size and shape of the top portion 80 of inflatable support structure 66. Similarly, the size and shape of the bottom portion 82 of inflatable support structure 66 is designed to be the same and/or similar to the size and shape of the top portion 84 of inflatable support structure 70; however, this is not required.

The inflatable support structures can be permanently or releaseably connected together. Likewise, inflatable roll top 62 can be permanently or releaseably connected to inflatable support structure 66.

Although separate valves and/or caps are illustrated for the inflatable roll top and each of the inflatable support structures, it can be appreciated that two or more of the components of the inflatable roll top 60 can fluidly be connected together such than two or more of the components of the inflatable roll top 60 can simultaneously inflated and/or deflated via a single valve and/or cap.

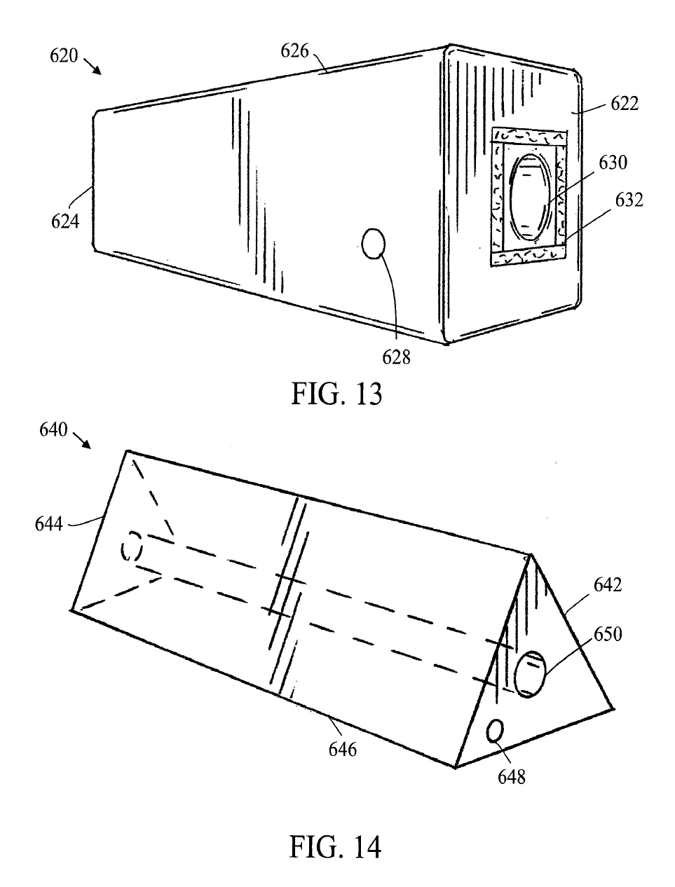

In use, the bottom surface 78 of inflatable roll top 62 can be connected to the top surface 80 of inflatable structure 66, and the bottom surface 82 of inflatable structure 66 can be connected to the top surface 84 of inflatable support structure 70; however, this is not required. The type of connection arrangement is non-limiting and can include one or more strips of Velcro™ provided on said surfaces (see FIG. 13) or one or more straps (see FIGS. 3, 5, 8, 10, 12), etc.

With continued reference to FIG. 2, inflatable roll top 60 optionally includes a weight structure in the form of a first weight sleeve 74 and a second weight sleeve 76. First weight sleeve 74 is illustrated as being connected along an edge of inflatable structure 70 where side panel 88 and bottom surface 86 meet. Similarly, second weight sleeve 76 is illustrated as being connected along an edge of inflatable structure 70 where side panel 90 and bottom surface 86 meet. First and second weight sleeves 74, 76 are illustrated as having a generally circular cross-sectional shape having at least one open end; however, other shapes can be used. First and second weight structures 74, 76 can include a weighting material, such as, for example, gravel, sand, liquid, gel, rod, pole, etc. First and second weight structures 74, 76 can have one or more open ends and/or valves and/or caps 77 designed to facilitate filling of the first and second weight structures with such weighted material; however, this is not required. The use of the weighting material is used to maintain the inflatable roll top in position and/or to inhibit or prevent the tipping of the inflatable roll top when contacted by a horse jumping over the inflatable roll top.

Although not shown, the interior of inflatable support structure 70 can be partially filled with weighted material prior to, during, and/or after the inflation of the inflatable support structure; however, this is not required. The valve and/or cap 72 can be used to insert and/or remove the weighted material from/into the interior cavity of the inflatable roll top. As also can be appreciated, a weighted structure can alternatively or additionally be positioned in the interior cavity of the inflatable support structure 70. If a weighted structure is optionally positioned in the interior cavity of the inflatable support structure, a valve and/or cap can be optionally positioned in at least one of the side panels to facilitate in the filling and/or unfilling of the weighted structure.

One non-limiting advantage of inflatable roll top 60 is that the height can be adjusted by selectively inflating one or more of the inflatable support structures 66, 70; however, this is not required. In one non-limiting example, beginner-level riders and/or horses can benefit from a shorter inflatable roll top 60, such as, for example, only inflating inflatable roll top 62. In such an example, inflatable support structures 66, 70 would be deflated, but still positioned underneath inflatable roll top 62. As the rider and/or horse progresses, an additional inflatable structure, such as, for example, inflatable support structure 66 can be inflated. As such, the height of inflatable roll top 60 can be controllably increased. Similarly, as the rider and/or horse further progresses, additional inflatable structures, such as, for example, inflatable support structure 70 can be inflated. As such, the height of the inflatable roll top 60 can be further increased. As such, inflatable roll top 60 can be used as a training device for beginner-level to advanced riders and/or horses; however, this is not required.

As can be appreciated, inflatable roll top 60 can include other or additional features, such as, for example, at least one connection arrangement (see FIGS. 3-4), a removeable cover (see FIG. 9), etc.

Referring now to FIG. 3, there is illustrated an inflatable horseshoe top 100 in accordance with another and/or alternative non-limiting aspect of the present invention. Inflatable horseshoe top 100 is illustrated as including a plurality of inflatable structures: 1) inflatable base structure 102, 2) first inflatable top structure 104, 3) second inflatable top structure 106, and 4) inflatable support structure 108.

As illustrated in FIG. 3, inflatable base structure 102 can be formed in a trapezoid-shaped structure comprising a bottom panel 110, a first end panel 112, a second end panel 114, a first side panel 116, a second side panel 118, and a top panel 120 connected together to define an internal cavity; however, other and/or alternative shapes can be used. Similarly, each panel 110, 112, 114, 116, 118, 120 described above can be formed from one or more separate panels of material; however, this is not required.

With continued reference to FIG. 3, first inflatable top structure 104 is illustrated as being formed in a generally columnar shape having a first side panel 122, a second side panel 124 and a top panel 126 extending along the edges therebetween, and defining an internal cavity; however, this is not required. Similarly, second inflatable top structure 106 is illustrated as being formed in a generally columnar shape having a first side panel 128, a second side panel 130, and a top panel 132 extending along the edges therebetween, and defining an internal cavity; however, this is not required. As can be appreciated, each panel 122, 124, 126, 128, 130, 132 described above can be formed from one or more separate panels of material; however, this is not required.

Generally, the internal cavity of the inflatable base structure 102 is designed to be continuous with the internal cavity of the first inflatable top structure 104 and second inflatable top structure 106; however, this is not required. As can be appreciated, first and second inflatable top structures 104, 106 can include internal cavities separate from the internal cavity of the inflatable base structure 102.

First end panel 112 of inflatable base structure 102 is illustrated in FIG. 3 as having a valve and/or cap 134 in and/or covering an opening in the base structure. Valve and/or cap 134 is generally designed to facilitate controlled inflation and/or controlled deflation of inflatable horseshoe top 100; however, this is not required. Inflatable horseshoe top 100 can be inflated by at least one air pump (see FIG. 19); however, this is not required. When inflated, as illustrated in FIG. 3, first and second inflatable top structures 104, 106 are designed to convey the appearance of a horseshow; however, this is not required. As such, first and second top inflatable structures 104, 106 can generally be designed to be arcuate and/or convex in shape; however, this is not required. As illustrated in FIG. 3, when inflated, first and second inflatable top structures 104, 106 extend upwardly from the top panel 120 of inflatable base structure 102.

With continued reference to FIG. 3, inflatable base structure 102 is illustrated as having one or more connection arrangements 136, 138 provided at or near a bottom edge thereof; however, this is not required. As can be appreciated, the one or more connection arrangements 136, 138 can be provided on any surface of inflatable horseshoe top 100. Connection arrangement 134 is illustrated as being in the form of a loop designed to facilitate insertion of a stake 138 therethrough. Similarly, connection arrangement 136 is illustrated as being in the form of a loop designed to facilitate the insertion of a stake 140 therethrough; however, this is not required. As can be appreciated, inflatable base structure 102 can include other or additional connection arrangements, such as, for example, Velcro™ (see FIG. 14), sleeves (see FIG. 2), etc. Although not illustrated, the base structure 102 can optionally include a first and/or second weight sleeves as described above with regard to FIGS. 1-2.

Inflatable base structure 102 is also illustrated in FIG. 3 as having a weight structure in the form of an optional internal bladder 142 having one or more sealed ends defining an internal cavity, and designed to be filled with one or more materials 144 (e.g., fluids [e.g., water, etc.], gels, solids [e.g., gravel, sand, etc.]) for the purpose of adding weight to inflatable horseshoe top 100. Generally, internal bladder 142 provides an internal cavity separate from the internal cavity of inflatable horseshoe top 100; however, this is not required. In one non-limiting embodiment, the internal bladder 142 is filled with water and the internal cavity of inflatable horseshoe top is filled with air; however, this is not required. As further illustrated in FIG. 3, one end 148 of internal bladder 142 is positionable at or near first side panel 112 of inflatable base structure 102. A valve and/or cap 146 can be provided on end 148 of internal bladder 142 in and/or covering an opening in the bladder. Valve and/or cap 146 is illustrated in FIG. 3 as traversing the boundary between the internal bladder 142 and inflatable horseshoe top 100, and as extending outwardly from first side panel 112 thereof; however, this is not required. In such a configuration, valve and/or cap 146 can be used to facilitate filling of the internal bladder 142 without filling the internal cavity of the inflatable horseshoe top 100.

With continued reference to FIG. 3, inflatable horseshoe top 100 is illustrated as including an inflatable support structure 108 designed to be removable from the inflatable horseshoe top 100. Inflatable support structure 108 is illustrated as being formed from a plurality of panels in a generally square cross-sectional shape defining an internal cavity; however, other or alternative shapes can be used. As illustrated in FIG. 3, inflatable support structure 108 is positionable on top of top panel 120 of inflatable base structure 102, and positionable between first and second inflatable top structures 104, 106; however, this is not required. Side panel 150 of inflatable structure 108 is illustrated in FIG. 3 as having a valve and/or cap 152 in and/or covering an opening in the side panel. Valve and/or cap 152 are generally designed to facilitate controlled inflation and/or deflation of inflatable support structure 108. Side panel 150 of inflatable support structure 108 is also illustrated as including one or more Velcro™ straps 154, 156 designed to releasably secure inflatable structure 108 to connection arrangements 158, 160 on inflatable base structure 102, respectively. As can be appreciated, the inflatable support structure can be irreleaseably or releasably connected to the inflatable base structure 102 by other or additional means (e.g., stitching, tether, zipper, Velcro™, adhesive, tape, straps, snaps, hooks, heated formed seam, etc.).

One non-limiting advantage of inflatable horseshoe top 100 is that the height can be adjusted by adding and/or removing inflatable support structure 108 from inflatable horseshoe top 100; however, this is not required. In one non-limiting example, beginner-level riders and/or horses would benefit from a shorter inflatable horseshoe top 100, such as, for example, an inflatable horseshoe top 100 absent inflatable structure 108 as illustrated in FIG. 4. As the rider and/or horse progresses, one or more additional inflatable structures, such as, for example, inflatable support structure 108 can be inflated and added to inflatable horseshoe top 100. As such, the height of inflatable horseshoe top can be increased so as to accommodate the skill level of various riders and/or horses; however, this is not required.

As can be appreciated, inflatable horseshoe top 100 can include other or additional features, such as, for example, a handle (see FIG. 1), an emergency air release zipper (see FIG. 1), one or more weight structures (see FIGS. 1-2), one or more inflatable support structures permanently or releasably connected to the base of the inflatable horseshoe top (see FIG. 2), one or more weight structures (see FIGS. 1-2), a removeable cover (see FIG. 9), etc.

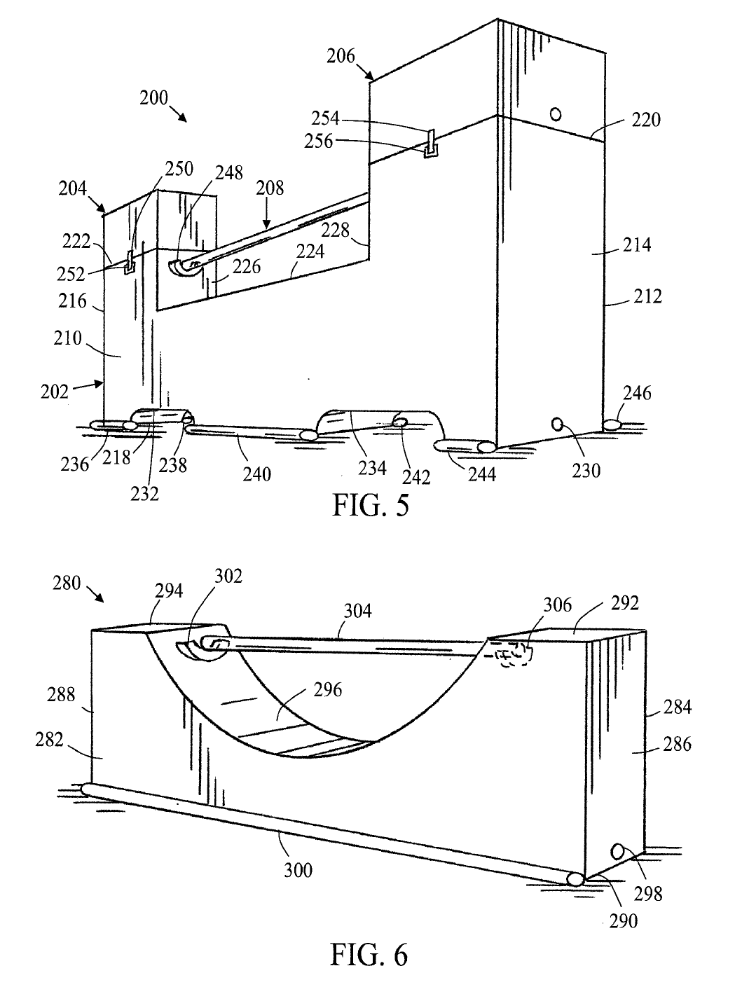

Referring now to FIG. 5, there is illustrated an inflatable square end horse jump 200 in accordance with another and/or alternative non-limiting aspect of the present invention. As illustrated in FIG. 5, inflatable square end horse jump 200 includes: 1) an inflatable base portion 202, 2) an inflatable support structure 204, 3) an inflatable support structure 206, and 4) a pole 208. As can be appreciated, inflatable square end horse jump 150 can be used absent inflatable support structure 204, inflatable support structure 206, and/or pole 208; however, this is not required.

As illustrated in FIG. 5, inflatable base portion 202 includes a front panel 210 having a general U-shape, a rear panel 212 having a general U-shape, a first side panel 214 having a generally rectangular shape, a second side panel 216 having a generally rectangular shape, a bottom panel 218 having a generally rectangular shape, a first top panel 220 having a generally rectangular shape, a second top panel 222 having a generally rectangular shape, a third top panel 224 having a generally rectangular shape, a first vertical panel 226 having a generally rectangular shape, and a second vertical panel 228. As can be appreciated; other shapes can be used for one or more of the panel. As can also be appreciated, two or more of the panels can be formed of a single piece of material. As illustrated in FIG. 5, the above panels 212, 214, 216, 218, 220, 222, 224, 226 can have an interior surface and an exterior surface, thereby providing an internal cavity of inflatable square end horse jump 200.

First side panel 214 is illustrated in FIG. 5 as including a valve and/or cap 230 in and/or covering an opening in the side panel. Valve and/or cap 230 is generally designed to facilitate controlled inflation and/or controlled deflation of the inflatable square end horse jump 200; however, this is not required.

With continued reference to FIG. 5, one or more passages and/or cutouts 232, 234 can optionally be provided through inflatable square end horse jump 200; however, this is not required. Although the one or more passages and/or cutouts 232, 234 are illustrated in FIG. 5 as being provided at or near the bottom panel 218 of inflatable square end horse jump 200, it can be appreciated that the one or more passages and/or cutouts 232, 234 can be provided through any panel of the inflatable square end horse jump 200.

With continued reference to FIG. 5, inflatable square end horse jump 200 optionally includes a plurality of weight structures 236, 238, 240, 242, 244, 246. Weight structures 236, 240, and 244 are illustrated as being provided at or near where front panel 210 and bottom panel 218 meet. Similarly, weight structures 238, 242, and 246 are illustrated as being provided at or near where back panel 212 and bottom panel 218 meet; however, this is not required. As can be appreciated, one or more weighted structures can be provided where first side portion 214 and bottom portion 218 meet, and/or where second side portion 216 and bottom portion 218 meet. The weighted structures can have the same or similar properties and functions as the weighted structures described above with reference to FIGS. 1-2.

With continued reference to FIG. 5, inflatable square end horse jump 200 is illustrated as optionally including a first inflatable support structure 204 and a second inflatable support structure 206 designed to be removable from the inflatable square end horse jump 200. Inflatable support structure 204 is illustrated as being formed from a plurality of panels in a generally rectangular cross-sectional shape, and positionable on second top panel 222 of inflatable square end horse jump 200; however, this is not required. Inflatable support structure 204 can include a connection arrangement (e.g., Velcro™ strap, zipper, snaps, tether, etc.) to enable the inflatable structure to be releasably connected to the inflatable base portion, and can include a valve and/or cap in and/or covering an opening in the inflatable structure to facilitate inflation and/or deflation of the inflatable structure 204; however, this is not required. As illustrated in FIG. 5, a Velcro™ strap 250 is illustrated as extending from a surface of inflatable structure 204, and as being releasably secured to a compatible Velcro™ strap or loop 252 positioned on the front panel 210 of inflatable square end horse jump 200; however, this is not required.

Similarly, inflatable support structure 206 is illustrated as being formed from a plurality of panels in a generally rectangular cross-sectional shape, and positionable on first top panel 220 of inflatable square end horse jump 200; however, this is not required. Inflatable support structure 206 can include a connection arrangement (e.g., Velcro™ strap, zipper, snaps, tether, etc.) to enable the inflatable structure to be releasably connected to the inflatable base portion, and can include a valve and/or cap in and/or covering an opening in the inflatable structure to facilitate inflation and/or deflation of the inflatable structure 206; however, this is not required. As illustrated in FIG. 5, a Velcro™ strap 254 is illustrated as extending from a surface of inflatable structure 206, and as being releasably secured to a compatible Velcro™ strap or loop 256 positioned on the front panel 210 of inflatable square end horse jump 200; however, this is not required.

Inflatable square end horse jump 200 can also include one or more cups 248 designed to temporarily and/or permanently hold pole 208; however, this is not required. In one specific embodiment, inflatable square end horse jump 200 includes first cup 248 positionable on first vertical panel 226, and a second cup (not shown) positionable on second vertical panel 228. As can be appreciated, more than one cup can be located on each of the vertical panels. The cups can be formed of one or more pieces of material, and can optionally be formed in a one-piece construction with first and second vertical panels 226, 228 of inflatable square end horse jump 200; however, this is not required. The cups can be formed to inflate and deflate, or formed of a material that constantly retains its shape (e.g., plastic material, metal material, etc.). As illustrated in FIG. 5, the one or more cups 248 can be generally U-shaped so as to inhibit or prevent the pole 208 from being easily displaced; however, the one or more cups can have other or alternative shapes. As can be appreciated, inflatable square end horse jump 200 can include other or additional features, such as, for example, a handle (see FIG. 1), an emergency air release zipper (see FIG. 1), at least one internal bladder (see FIGS. 3-4), at least one connection arrangement (see FIGS. 3-4), one or more inflatable support structures permanently or releasably connected to the base of the inflatable square end horse jump (see FIG. 2), a removeable cover (see FIG. 9), etc.

Referring now to FIG. 6, there is illustrated an inflatable bowl cut horse jump 280 in accordance with another and/or alternative non-limiting aspect of the present invention. Inflatable bowl cut horse jump 200 includes a front panel 282 can have a general U-shape, a rear panel 284 having a general U-shape, a first side panel 286 having a generally rectangular shape, a second side panel 288 having a generally rectangular shape, a bottom panel 290 having a generally rectangular shape, a first top panel 292 having a generally rectangular shape, a second top panel 294 having a generally rectangular shape, and a third top panel 296 having a generally rectangular shape. As can be appreciated; other shapes can be used for one or more of the panel. As can also be appreciated, two or more of the panels can be formed of a single piece of material. As illustrated in FIG. 6, the above panels 282, 284, 286, 288, 290, 292 can have an interior surface and an exterior surface, thereby providing an internal cavity of inflatable bowl cut horse jump 280.

First side panel 286 is illustrated in FIG. 6 as including a valve and/or cap 298 in and/or covering an opening in the side panel. Valve and/or cap 298 is generally designed to facilitate controlled inflation and/or controlled deflation of the inflatable bowl cut horse jump 280; however, this is not required.

With continued reference to FIG. 6, inflatable bowl cut horse jump 280 optionally includes at least one weight structure 300. Weight structure 300 is illustrated as being provided at or near where front panel 282 and bottom panel 290 meet. As can be appreciated, the at least one weight structure can be provided on any other surface and/or edge of inflatable bowl cut horst jump; however, this is not required. The one or more weighted structures can have the same or similar properties and functions as the weighted structures described above with reference to FIGS. 1-2.

Inflatable bowl cut horse jump 280 can also include one or more cups 302, 306 designed to temporarily and/or permanently hold pole 304 in place across the inflatable structure; however, this is not required. The one or more cups can have the same or similar properties and features as the cups described with reference to FIG. 5. In one specific embodiment, inflatable bowl cut horse jump 280 includes first cup 302 positionable on a first end of third top panel 296, and a second cup 306 positionable on a second end of third top panel 296, said second end opposite the first end; however, this is not required. The cups 302, 306 can be formed of one or more pieces of material, and can optionally be formed in a one-piece construction with third top panel 296 of inflatable bowl cut horse jump 280; however, this is not required. As illustrated in FIG. 6, the one or more cups 302, 306 can be generally U-shaped so as to prevent the pole 304 from being easily displaced; however, the one or more cups can have other or alternative shapes. As can be appreciated, the first and third panels can include more than one cup; however, this is not required.

As can be appreciated, inflatable bowl cut horse jump 280 can include other or additional features, such as, for example, a handle (see FIG. 1), an emergency air release zipper (see FIG. 1), at least one internal bladder (see FIGS. 3-4), at least one connection arrangement (see FIGS. 3-4), one or more inflatable support structures releasably connected to the top sides of the inflatable bowl cut horse jump (see FIG. 5), one or more inflatable support structures permanently or releasably connected to the base of the inflatable bowl cut horse jump (see FIG. 2), a removeable cover (see FIG. 9), etc.

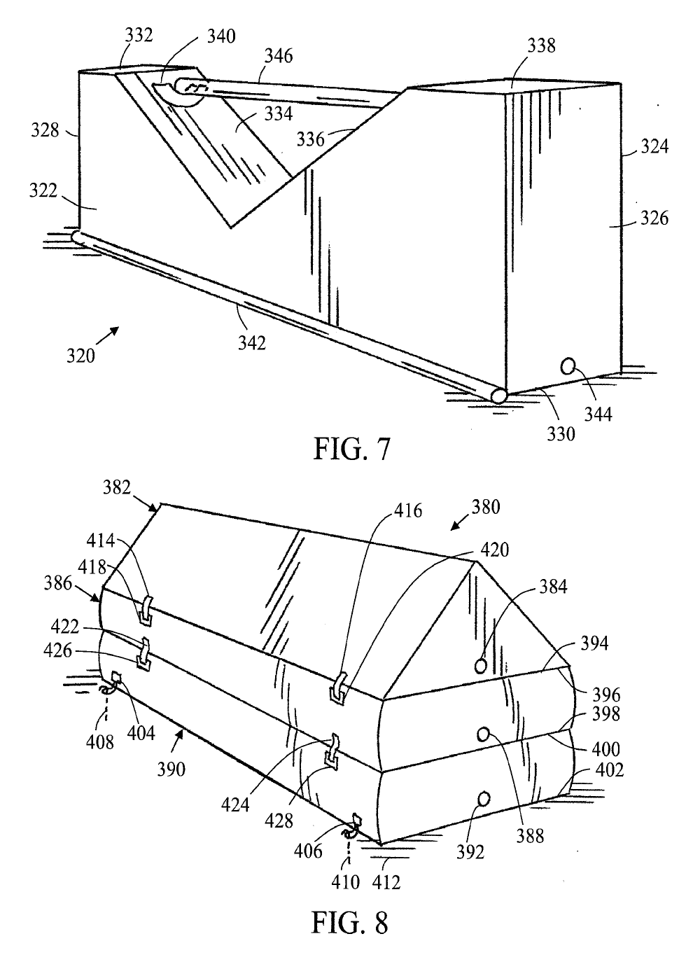

Referring now to FIG. 7, there is illustrated an inflatable V-cut horse jump 320 in accordance with another and/or alternative non-limiting aspect of the present invention. Inflatable V-cut horse jump 320 includes a front panel 322 can have a general V-shape, a rear panel 324 having a general V-shape, a first side panel 326 having a generally rectangular shape, a second side panel 328 having a generally rectangular shape, a bottom panel 330 having a generally rectangular shape, a first top panel 332 having a generally rectangular shape, a second top panel 334 having a generally rectangular shape, a third top panel 336 having a generally rectangular shape, and a fourth top panel 338 having a generally rectangular shape. As can be appreciated; other shapes can be used for one or more of the panel. As can also be appreciated, two or more of the panels can be formed of a single piece of material. As illustrated in FIG. 7, the above panels 322, 324, 326, 328, 330, 332, 334, 336, 338 can have an interior surface and an exterior surface, thereby providing an internal cavity of inflatable V-cut horse jump 320.

First side panel 326 is illustrated in FIG. 7 as including a valve and/or cap 344 in and/or covering an opening in the side panel. Valve and/or cap 344 is generally designed to facilitate controlled inflation and/or controlled deflation of the inflatable V-cut horse jump 320; however, this is not required.

With continued reference to FIG. 7, inflatable V-cut horse jump 320 also optionally includes at least one weight structure 342. Weight structure 342 is illustrated as being provided at or near where front panel 322 and bottom panel 330 meet. As can be appreciated, the at least one weight structure can be provided on any other surface and/or edge of inflatable V-cut horse jump 320; however, this is not required. The one or more weighted structures can have the same or similar properties and functions as the weighted structures described above with reference to FIGS. 1-2.

Inflatable V-cut horse jump 320 can also include one or more cups 340 designed to temporarily and/or permanently hold pole 346 in place across the inflatable structure; however, this is not required. The one or more cups can have the same or similar properties and features as the cups described with reference to FIG. 5. In one specific embodiment, inflatable V-cut horse jump 320 includes first cup 340 positionable on second top panel 334, and a second cup (not shown) positionable on third top panel 336; however, this is not required. The cups can be formed of one or more pieces of material, and can optionally be formed in a one-piece construction with top panels 334, 336 of inflatable V-cut horse jump 320; however, this is not required. As illustrated in FIG. 7, the one or more cups can be generally U-shaped so as to prevent the pole 346 from being easily displaced; however, the one or more cups can have other or alternative shapes. As can be appreciated, the second and third panels can include more than one cup; however, this is not required.

As can be appreciated, inflatable V-cut horse jump 320 can include other or additional features, such as, for example, a handle (see FIG. 1), an emergency air release zipper (see FIG. 1), at least one internal bladder (see FIGS. 3-4), at least one connection arrangement (see FIGS. 3-4), one or more inflatable support structures releasably connected to the top sides of the inflatable V-cut horse jump (see FIG. 5), one or more inflatable support structures permanently or releasably connected to the base of the inflatable V-cut horse jump (see FIG. 2), a removeable cover (see FIG. 9), etc.

Referring now to FIG. 8, there is illustrated an inflatable cone top 380 in accordance with another and/or alternative non-limiting aspect of the present invention. Inflatable cone top 380 is illustrated as including three separate inflatable structures 1) an inflatable cone top 382 having a valve and/or cap 384 in and/or covering an opening in the cone top, 2) a first inflatable support structure 386 having a valve and/or cap 388 in and/or covering an opening in the support structure, and 3) a second inflatable support structure 390 having a valve and/or cap 392 in and/or covering an opening in the support structure; however, this is not required. As can be appreciated, inflatable cone top 380 can include additional and/or alternative inflatable structures. The first and second support structures have a generally rectangular cross-sectional shape; however, this is not required.

Inflatable cone top 382 is illustrated as providing at least a bottom surface 394 being planar and having a generally rectangular shape; however, other or alternative shapes can be used. Inflatable support structure 386 is illustrated as providing at least a top surface 396 being planar and having a generally rectangular shape, and a bottom surface 398 being planar and having a generally rectangular shape; however, other or alternative shapes can be used. As can also be appreciated, two or more of the panels can be formed of a single piece of material. Inflatable support structure 390 is illustrated as providing at least a top surface 400 being planar and having a generally rectangular shape, and a bottom surface 402 being planar and having a generally rectangular shape; however, other or alternative shapes can be used. As can also be appreciated, two or more of the panels can be formed of a single piece of material. Generally, the size and shape of bottom portion 394 of inflatable cone top 382 is designed to be the same and/or similar to the size and shape of the top portion 396 of inflatable support structure 386. Similarly, the size and shape of the bottom portion 398 of inflatable support structure 386 is designed to be the same and/or similar to the size and shape of the top portion 400 of inflatable support structure 390; however, this is not required.

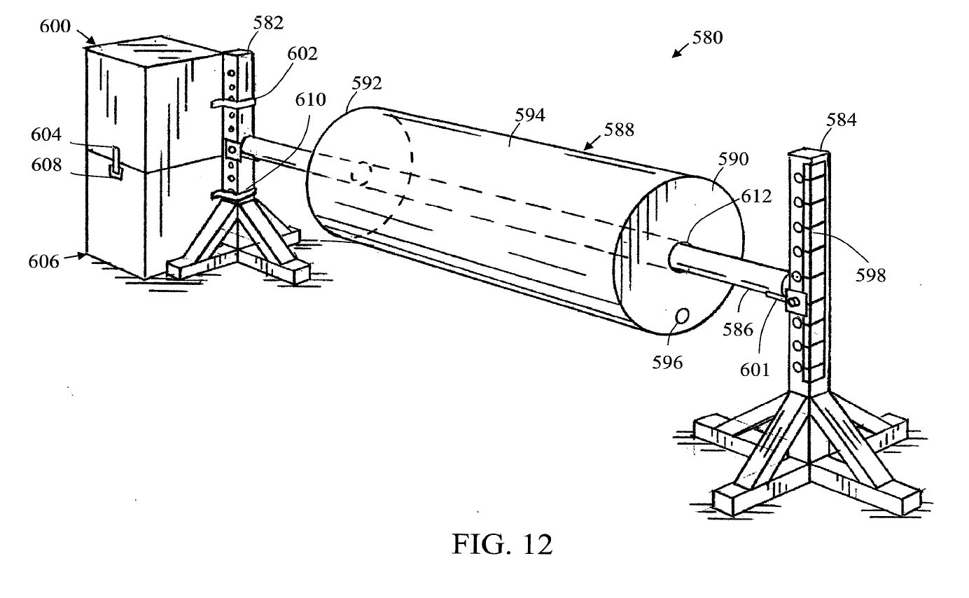

In use, the bottom surface 394 of inflatable cone top 382 can be releasably connected to the top surface 396 of inflatable support structure 386, and the bottom surface 398 of inflatable structure 386 can be releasably connected to the top surface 400 of inflatable support structure 390; however, this is not required. The type of connection arrangement is non-limiting and can include one or more strips of Velcro™ provided on said surfaces (see FIG. 12) or one or more straps (see FIG. 8), etc.

With continued reference to FIG. 8, inflatable cone top 380 also includes a first loop 404 and a second loop 406. First loop 404 is illustrated as being connected along an edge of inflatable support structure 390. Similarly, second loop 406 is illustrated as being connected along an edge of inflatable support structure 390, said first loop 404 being spaced apart from second loop 406. First and second loops 404, 406 are illustrated as being designed to facilitate insertion of a first and second stake 408, 410, respectively, therethrough. As such, the first and second loops 404, 406 can be used for the purpose of holding inflatable cone top 380 against the ground 412; however, this is not required.

Inflatable cone top 382 is illustrated as having a first Velcro™ strap 414 and a second Velcro™ strap designed to temporarily secure inflatable cone top 382 to first Velcro™ 418 and second Velcro™ 420 on inflatable support structure 386. Similarly, inflatable support structure 386 is illustrated as having a first Velcro™ strap 422 and a second Velcro™ strap designed to temporarily secure inflatable support structure 386 to first Velcro™ 426 and second Velcro™, respectively on inflatable support structure 390. As can be appreciated, other or additional connection arrangements can be used (e.g., zipper, snaps, tether, etc.)

One non-limiting advantage of inflatable cone top 380 (similar to the non-limiting advantage of inflatable roll top 60 in as described with reference to FIG. 2) is that the height can be adjusted by selectively inflating one or more of the inflatable support structures 386, 390; however, this is not required.

As can be appreciated, inflatable cone top 382 can include other or additional features, such as, for example, a handle (see FIG. 1), an emergency air release zipper (see FIG. 1), at least one internal bladder (see FIGS. 3-4), one or more weight structures (see FIGS. 1-2), a removeable cover (see FIG. 9), etc.

Referring now to FIG. 9, there is illustrated an inflatable round top horse jump 440 in accordance with another and/or alternative non-limiting aspect of the present invention. Inflatable round top horse jump includes a front panel 442 having a general W-shape, a rear panel 444 having a general W-shape, a first side panel 446 having a generally rectangular shape, a second side panel 448 having a generally rectangular shape, a bottom panel 450 having a generally rectangular shape, a first top panel 452 having a generally rectangular shape, a second top panel 454 having a generally rectangular shape, a third top panel 456 having a generally rectangular shape, a first vertical panel 458 having a generally rectangular shape, and a second vertical panel 460. As can be appreciated; other shapes can be used for one or more of the panel. As can also be appreciated, two or more of the panels can be formed of a single piece of material. As illustrated in FIG. 9, the above panels 442, 444, 446, 448, 450, 452, 454, 456, 458, 460 can have an interior surface and an exterior surface, thereby providing an internal cavity of inflatable round top horse jump 440.

First side panel 446 is illustrated in FIG. 9 as including a valve and/or cap 462 in and/or covering an opening in the side panel. Valve and/or cap 462 is generally designed to facilitate controlled inflation and/or controlled deflation of the inflatable round top horse jump 440; however, this is not required.

With continued reference to FIG. 9, inflatable round top horse jump 440 also includes a plurality of loops 464 extending outwardly from a lower portion thereof, said plurality of loops generally designed to facilitate insertion of stake 466 therethrough for the purpose of securing inflatable round top horse jump 440 against the ground; however, this is not required.

With continued reference to FIG. 9, inflatable round top horse jump 440 is illustrated as including a cover 468. Cover 468 is illustrated as being provided on one surface of inflatable round top horse jump 440; however, it can be appreciated that a cover can be provided on any or all surfaces of the inflatable structure. As illustrated in FIG. 9, a plurality of Velcro™ straps 470 can be removably attached to the cover 468 for the purpose of attaching said cover 468 to inflatable round top horse jump 440. As such, a plurality of Velcro™ 472 is provided on one or more panels of the inflatable round top horse jump 440; however, this is not required. As can be appreciated, other or additional connection arrangements can be used (e.g., snaps, adhesive, straps, tether, zipper, etc.). The cover can optionally include a different type of print one each side to create a different look of the inflatable round top horse jump when the cover is connected on a certain side (e.g., brick face look, stacked log look, wood panel look, stone face look, fence look, bushes look, vegetation look, tree trunk look, etc.).

Inflatable round top horse jump 440 can also include one or more cups designed to temporarily and/or permanently hold pole 478; however, this is not required. In one specific embodiment, inflatable round top horse jump 400 includes first cup 476 positionable on first vertical panel 458, and a second cup (not shown) positionable on second vertical panel 460. The cups can be formed of one or more pieces of material, and can optionally be formed in a one-piece construction with first and second vertical panels 458, 460 of inflatable round top horse jump 440; however, this is not required. As illustrated in FIG. 9, the one or more cups 476 can be generally U-shaped so as to prevent the pole 478 from being easily displaced; however, the one or more cups can have other or alternative shapes. The one or more cups can have similar functions and features as the cups described above with reference to FIGS. 5-6.

As can be appreciated, inflatable round top horse jump 440 can include other or additional features, such as, for example, a handle (see FIG. 1), an emergency air release zipper (see FIG. 1), at least one internal bladder (see FIGS. 3-4), at least one connection arrangement (see FIGS. 3-4), one or more inflatable support structures releasably connected to the top sides of the inflatable round top horse jump (see FIG. 5), one or more inflatable support structures permanently or releasably connected to the base of the inflatable round top horse jump (see FIG. 2), etc.

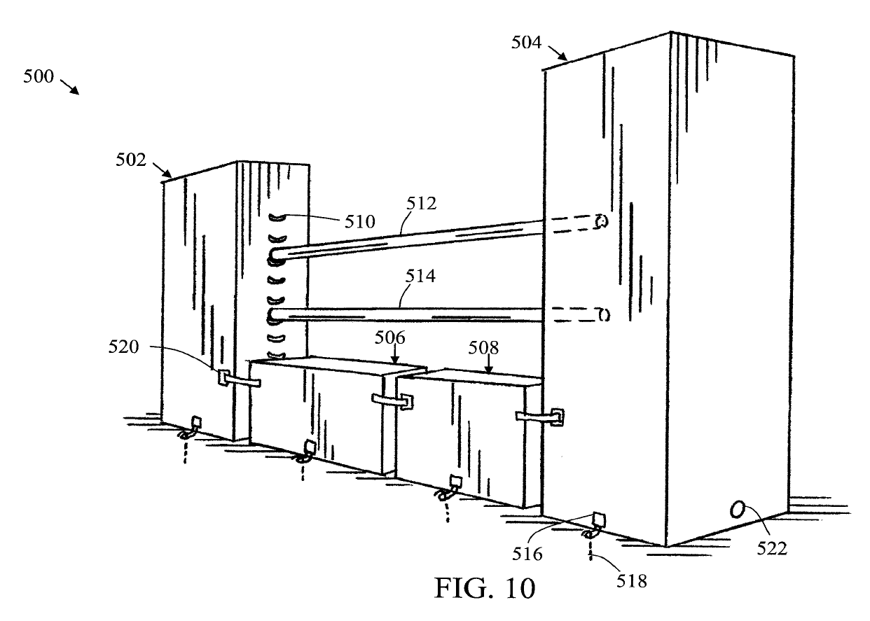

Referring now to FIG. 10, there is illustrated an inflatable horse jump 500 including a first standard 502, a second standard 504, a first support structure 506 (optionally an inflatable structure, and a second support structure 508 (optionally an inflatable structure). First standard 502 and second standard 504 are illustrated as having a generally rectangular cross-sectional shape; however, this is not required. Similarly, first standard 502 and second standard 504 include a plurality of cups 510 designed to hold one or more poles 512, 514; however, this is not required. The plurality of cups provided on first standard 502 are generally designed to be aligned with the plurality of cups provided on second standard 504; however, this is not required. As illustrated in FIG. 10, first standard 502 and second standard 504 can be the same or different.

With continued reference to FIG. 10, inflatable horse jump 500 includes a first support structure 506 and a second support structure 508 which are designed to be positioned between the first and second standards 502, 504; however, this is not required. Generally, first standard 502, second standard 504, first support structure 504, and second support structure 506 can include a valve and/or cap in and/or covering an opening, as shown by 522 for second standard 504. As can be appreciated, first and second support structure may or may not be inflatable structures.

As illustrated in FIG. 10, first standard 502, second standard 504, first support structure 506, and second support structure 508 include a plurality of loops, one of which is labeled as 516 extending outwardly from a lower portion thereof, said plurality of loops generally designed to facilitate insertion of stake 518 therethrough for the purpose of securing one or more components of inflatable horse jump 500 against the ground (e.g., ground poles, etc.); however, this is not required. As also illustrated in FIG. 10, first standard 502, second standard 504, first support structure 506, and second support structure 508 can be temporarily or permanently connected by a plurality of Velcro™ straps, one of which is labeled as 520; however, this is not required. As can be appreciated; other or additional connection arrangements can be used (e.g., straps, tether, zipper, snaps, etc.)

As can be appreciated, one or more of first standard 502 (or optional filler), second standard 504, first support structure 506, and/or second support structure 508 can include other or additional features, such as, for example, a handle (see FIG. 1), an emergency air release zipper (see FIG. 1), at least one internal bladder (see FIGS. 3-4), at least one connection arrangement (see FIGS. 3-4), one or more weight structures (see FIGS. 1-2), one or more inflatable support structures releasably connected to the top sides of the first and/or second standards (see FIG. 5), one or more inflatable support structures permanently or releasably connected to the base of the first and/or second standards (see FIG. 2), a removeable cover (see FIG. 9), etc.

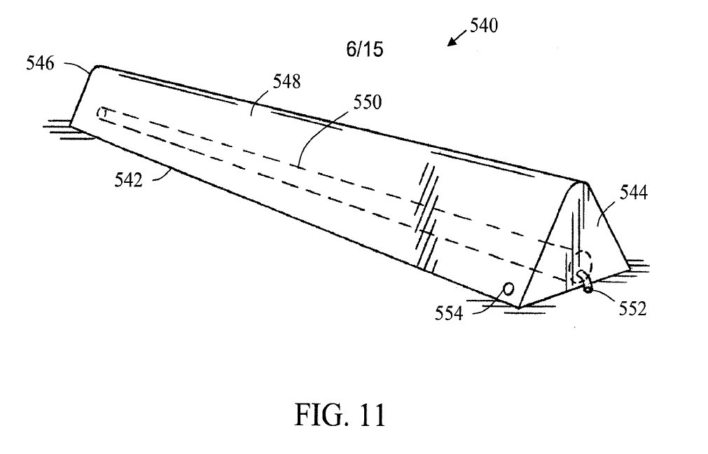

Referring now to FIG. 11, there is illustrated an inflatable arena border 540 according to another and/or alternative non-limiting aspect of the present invention. Inflatable arena border 540 is illustrated as having a triangular cross-sectional shape and as being formed from a bottom panel 542, a first end panel 544, a second end panel 546, and a top panel 548; however, other shapes can be used. Two or more panels can be formed of a single sheet of material; however, this is not required. Top panel 548 is illustrated in FIG. 11 as including a valve and/or cap 554 in and/or covering an opening in the top panel. Valve and/or cap 554 is generally designed to facilitate the controlled inflation and/or controlled deflation of the inflatable round top horse jump 440; however, this is not required.

With continued reference to FIG. 11, inflatable arena border 540 is illustrated as including an internal bladder 550 having a valve 552; however, this is not required. Generally, internal bladder 550 is used to add weight to the inflatable arena 540 structure to hold the inflatable arena border 540 against the ground; however, this is not required.

As can be appreciated, inflatable arena border 540 can include other or additional features, such as, for example, a handle (see FIG. 1), an emergency air release zipper (see FIG. 1), at least one connection arrangement (see FIGS. 1-10), at least one loop structure (see FIG. 10), one or more weight structures (see FIGS. 1-2), one or more inflatable support structures permanently or releasably connected to the base of the inflatable arena border (see FIG. 2), a removeable cover (see FIG. 9), etc.

Referring now to FIG. 12, there is illustrated horse course equipment 580 in accordance with another and/or alternative non-limiting aspect of the present invention. Inflatable horse course equipment 580 is illustrated as including a first standard 582 and a second standard 584 spaced apart and pole 586 supported at each end in a cup 601 on each of the standards. The standards and pole are not formed of inflatable structures. As such, a traditional horse jump is provided.

With continued reference to FIG. 12, horse course equipment optionally includes an inflatable pole cover 588 having a cylindrical shape. Inflatable pole cover 588 is illustrated as being formed from a body panel 594, a first end panel 590, and a second end panel 592, and as having a hole and/or aperture 612 therethrough; however, this is not required. Hole and/or aperture 612 are generally designed to accommodate the insertion of pole 586 therethrough. The inflatable pole cover can cover the full or a portion of the length of the pole. Generally, the inflatable pole cover covers at least 60% the length of the pole (e.g., 60-100% and all values and ranges therebetween); however, the inflatable pole cover can cover less than 60% the length of the pole. As can be appreciated, inflatable pole cover 588 can include other or additional features, such as, for example, a handle (see FIG. 1), an emergency air release zipper (see FIG. 1), a connection arrangement at the end face of the inflatable pole cover (see FIG. 13), a removeable cover, etc. In another and/or alternative non-limiting embodiment, inflatable pole cover 588 can be designed to be inserted vertically over a vertical support such for example first standard 582 or second standard 584 or some other types of vertical support; however, this is not required. As such, inflatable pole filler 588 can be used as an inflatable standard; however, this is not required. In such a configuration, inflatable pole filer 588 can be used to increase the safety of existing horse jump equipment and systems.

The horse course equipment 580 is also illustrated in FIG. 12 as optionally including tape 598 attached to second standard 584. As can be appreciated, tape 598 can be used on any other standard, such as, for example, standard 582, or any other horse course equipment. Tape 598 is generally designed to be adhered to a surface of a standard for the purpose of allowing a user to write the height at which a rider and/or horse jumped thereon; however, this is not required. The tape can optionally include numbers that are used to represent the height of the pole on the standard; however, this is not required. In one non-limiting configuration, tape 598 is designed to be dry erase so as to provide easy and convenient writing and/or erasing. In another and/or alternative non-limiting configuration, tape 598 is designed to be durable to withstand various indoor and outdoor weather conditions.

With continued reference to FIG. 12, there is illustrated a first inflatable support structure 600 being stacked on a second inflatable support structure 606; however, this is not required. First and second inflatable support structure 600, 606 can be the same in structure and/or function as first and second inflatable support structure 506, 508 in FIG. 10; however, this is not required. As illustrated in FIG. 12, first inflatable support structure 600 is illustrated as having a Velcro™ strap 604 designed to attach to a Velcro™ 608 on second inflatable support structure 606; however, this is not required. Similarly, first and second inflatable support structure 600, 606 are illustrated as including Velcro™ loops 602, 610, respectively for the purpose of securing the first and second inflatable support structure 600, 606 against first standard 582. As can be appreciated, other or additional arrangements can be used to secure the inflatable support structure to the standards. As can be appreciated, using such Velcro™ straps, one or more inflatable support structure can be used to design and/or construct various types of inflatable horse course equipment, structures, and courses; however, this is not required. As can be appreciated, one or both of the inflatable support structures can include other or additional features, such as, for example, a handle (see FIG. 1), an emergency air release zipper (see FIG. 1), at least one connection arrangement (see FIGS. 1-10), at least one loop structure (see FIG. 10), one or more weight structures (see FIGS. 1-2) etc.

Referring now to FIG. 13, there is illustrated an inflatable pole cover 620 in accordance with another and/or alternative non-limiting aspect of the present invention. Inflatable pole cover 620 has a square cross-sectional shape and is formed of a first end panel 622, a second end panel 624, and a body panel 626. Body panel 626 is illustrated as including a valve and/or cap 628 in and/or covering an opening in the body panel for the purpose of facilitating inflation and/or deflation of inflatable pole cover 620; however, valve and/or cap 628 can be provided at other or alternative panels of the inflatable pole cover 620. Front panel 622 is illustrated as including a hole and/or aperture 630 extending through inflatable pole cover 620 from first end panel 622 through second end panel 624. Hole and/or aperture 630 is generally designed to facilitate insertion of a pole (see FIG. 12) therethrough. Front panel 622 is also illustrated as including one or more Velcro™ strips 632. The one or more Velcro™ strips are designed to facilitate attachment of inflatable pole cover 620 to another inflatable pole cover on the pole, or some other inflatable horse course equipment component and/or some other non-inflatable structure; however, this is not required. As can be appreciated, inflatable pole cover 620 can include other or additional features, such as, for example, a handle (see FIG. 1), an emergency air release zipper (see FIG. 1), a removeable cover, etc. In another and/or alternative non-limiting embodiment, inflatable pole cover 620 can be designed to be inserted vertically over an existing upright horse standard, such as, for example, first standard 582 of FIG. 12; however, this is not required. In such a configuration, inflatable pole cover 620 can be used to increase the safety of existing horse jump systems; however, this is not required. As such, inflatable pole cover 620 can be used as an inflatable standard; however, this is not required.

Referring now to FIG. 14, there is illustrated an inflatable pole cover 640 in accordance with another and/or alternative non-limiting aspect of the present invention. Inflatable pole cover 640 has a triangular cross-sectional shape and is formed of a first end panel 642, a second end panel 644, and a body panel 646. Body panel 646 is illustrated as including a valve and/or cap 648 in and/or covering an opening in the body panel for the purpose of facilitating inflation and/or deflation of inflatable pole cover 640; however, valve and/or cap 648 can be provided at other or alternative panels of the inflatable pole cover 640. Front panel 642 is illustrated as including a hole and/or aperture 650 extending through inflatable pole cover 640 from first end panel 642 through second end panel 642. Hole and/or aperture 650 is generally designed to facilitate insertion of a pole (see FIG. 12) therethrough. As can be appreciated, inflatable pole cover 640 can include other or additional features, such as, for example, a handle (see FIG. 1), an emergency air release zipper (see FIG. 1), a connection arrangement at the end face of the inflatable pole cover (see FIG. 13), a removeable cover, etc. In another and/or alternative non-limiting embodiment, inflatable pole cover 640 can be designed to be inserted vertically over an existing upright horse standard, such as, for example, first standard 582 of FIG. 12; however, this is not required. As such, inflatable pole cover 640 can be used as an inflatable standard; however, this is not required.

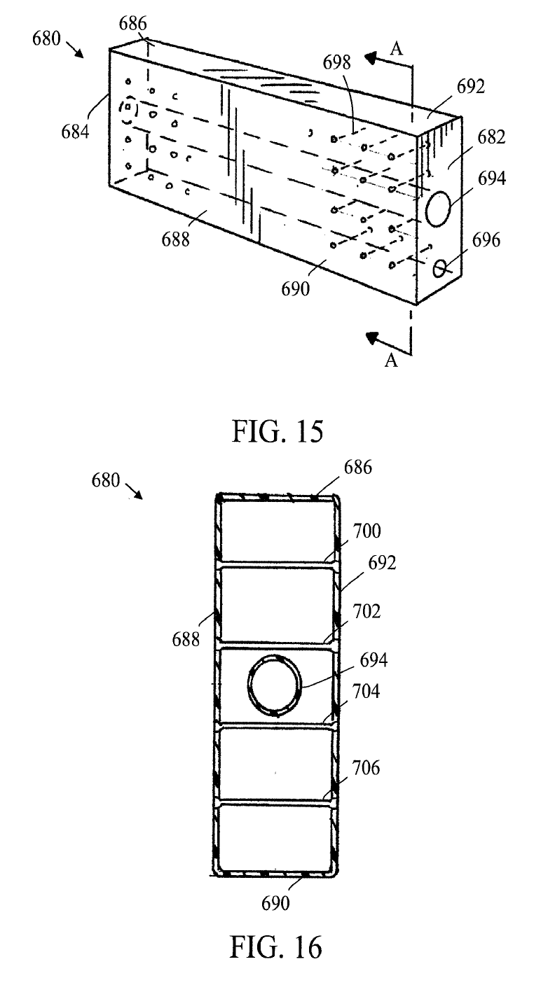

Referring now to FIG. 15, there is illustrated an inflatable pole cover 680 in accordance with another and/or alternative non-limiting aspect of the present invention. Inflatable pole cover 680 has a rectangular cross-sectional shape and is formed of a first end panel 682, a second end panel 684, a top panel 686, a front panel 688, a bottom panel 690, and a rear panel 692. First end panel 682 is illustrated as including a valve and/or cap 696 in and/or covering an opening in the end panel for the purpose of facilitating inflation and/or deflation of inflatable pole cover 680; however, valve and/or cap 696 can be provided at other or alternative panels of the inflatable pole cover 680. First end panel 682 is illustrated as including a hole and/or aperture 694 extending through inflatable pole cover 680 from first end panel 682 through second end panel 684. Hole and/or aperture 694 is generally designed to facilitate insertion of a pole (see FIG. 12) therethrough. As can be appreciated, inflatable pole cover 680 can include other or additional features, such as, for example, a handle (see FIG. 1), an emergency air release zipper (see FIG. 1), a connection arrangement at the end face of the inflatable pole cover (see FIG. 13), a removeable cover, etc. In another and/or alternative non-limiting embodiment, inflatable pole cover 680 can be designed to be inserted vertically over an existing upright horse standard, such as, for example, first standard 582 of FIG. 12; however, this is not required. As such, inflatable pole cover 680 can be used as an inflatable standard; however, this is not required.

Referring now to FIG. 16, there is illustrated a cross-sectional view of inflatable pole cover 680 of FIG. 15 along line A-A. As illustrated in FIGS. 15-16, one or more connectors 698 can be used to increase the structural integrity of the inflatable pole cover 680; however, this is not required. As illustrated in FIG. 16, inflatable pole cover 680 includes one or more connectors (e.g., rope, wire, tubing, twine, etc.) 700, 702, 704, 706 designed to connect the front panel 688 to the rear panel 692. Without connectors 700, 702, 704, 706 or other and/or alternative connection arrangements, when inflatable cover 680 is filled with air, the inflatable structure would be susceptible to bowing outwardly, thereby deforming from the intended shape of the inflatable structure. The connectors are generally formed of a non-rigid material so that when the inflatable pole cover is deflated, it can be rolled up and or folded without any interference from the connectors; however, this is not required. In one non-limiting embodiment, the connectors are formed of nylon string or cord. As can be appreciated, the inflatable pole covers illustrated in FIGS. 12-14 can optionally include one or more connectors to maintain the shape of the inflatable structure when inflated. As also can be appreciated, any of the inflatable structures illustrated in FIGS. 1-11 can optionally include one or more connectors to maintain the shape of the inflatable structure when inflated. The ends of the connectors can be connected to the surface of the inflatable structure by any number of arrangements (e.g., Velcro™, hooks, adhesive, snaps, ties, melted connection, etc.).

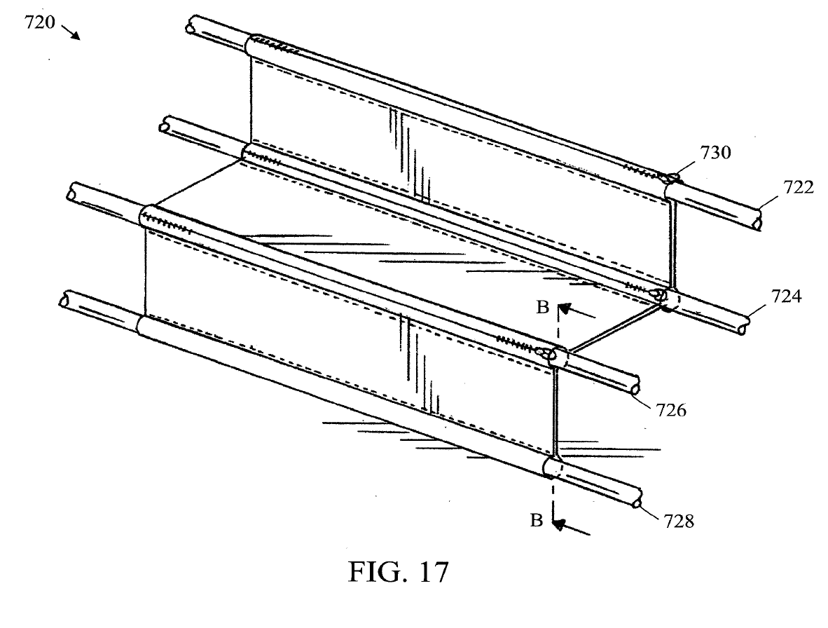

Referring now to FIG. 17, there is illustrated a pole skin 720 in accordance with another and/or alternative non-limiting aspect of the present invention. Pole skin 720 is designed to connect to a plurality of poles. As illustrated in FIG. 17, the pole skin is configured to be connected to four poles 722, 724, 726, 728; however, it can be appreciated that other numbers of poles can be connected together by the pole skin. Generally, pole skin 720 can be designed to cover one or more poles set up in a horse course; however, this is not required. As such, with reference with FIG. 17, at least a portion of pole skin 720 is designed to partially or fully enclose the poles. Similarly, pole skin 720 can be designed to cover the gap between one or more poles when the poles are connected to horse course equipment; however, this is not required. As such, with continued reference to FIG. 17, at least a portion of pole skin 720 is designed to partially or fully extend from pole 722 to pole 724, at least a portion of pole skin 720 is designed to partially or fully extend from pole 724 to pole 726, and at least a portion of pole skin 720 is designed to partially or fully extend from pole 726 to pole 728; however, this is not required. Although pole skin 720 is illustrated as being used with poles arranged in a step up orientation, it can be appreciated that pole skin 720 can be easily and conveniently used with poles arranged in other or alternative orientations (e.g., box, wedge, etc.) based on the arrangement of poles used.

Pole skin 720 can be formed from one or more panels of material; however, this is not required. As illustrated in FIG. 17, a plurality of zippers, one of which is labeled as 730, can optionally be used to secure one or more parts of pole skin 720 together; however, this is not required. Generally the material is a flexible, durable, bendable and foldable material. Non-limiting materials include fabric, plastic sheeting, reinforced plastic sheeting, etc.

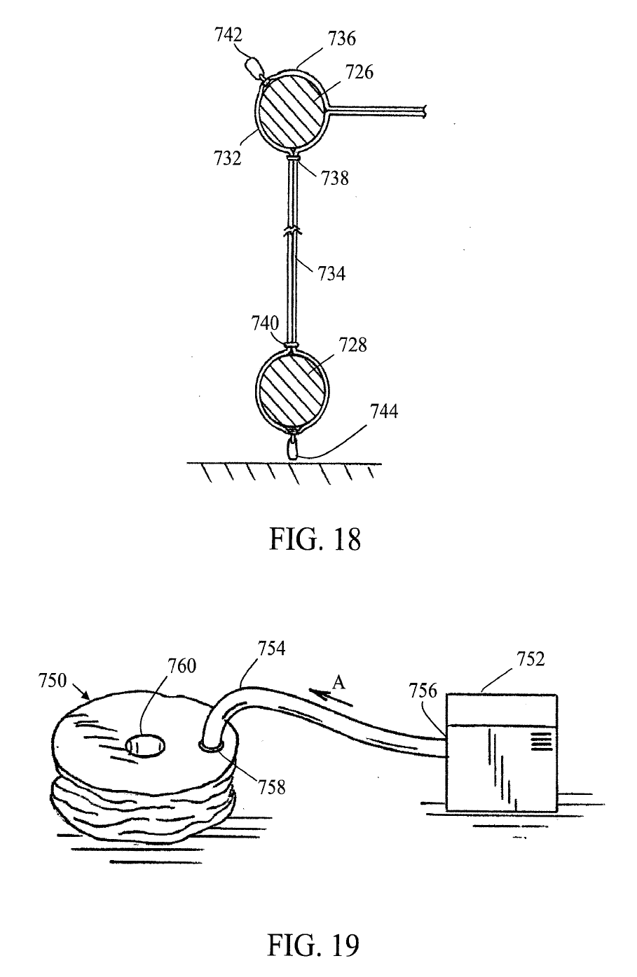

Referring now to FIG. 18, there is illustrated a cross-sectional view of pole skin 720 of FIG. 17 taken along B-B of FIG. 17. Pole skin 720 can be at least partially composed of a first portion 732, a second portion 734, and a third portion 736; however, this is not required. As illustrated in FIG. 18, pole 726 can be at least partially enclosed by: 1) first portion 732, 2) second portion 734, and/or 3) third portion 736; however, this is not required. First portion 732 and second portion 734 are illustrated as being connected together by stitching 738 at or near the surface of pole 726. Similarly, first portion 732 and second portion 734 are illustrated as being connected together by stitching 740 at or near the surface of pole 738. Second portion 734 and third portion 736 can be partially or fully connected together by one or more adhesives (not shown) provided between said second portion 734 material and said third portion 736 material; however, this is not required. First portion 732 and third portion 736 are illustrated as being connected together by zipper 742 at or near the surface of pole 726. Similarly, first portion 732 and second portion 734 are illustrated as being connected together by zipper 744 positioned at or near the surface of pole 728; however, this is not required. As such, zippers 724, 744 can be used to facilitate the easy and convenient attachment of pole skin 720 to poles 726, 728.

The front or back face of the pole skin can include printed text (e.g., advertisement, numbers, information by obstacle, etc.) and/or pictures (e.g., brick face look, stacked log look, wood panel look, stone face look, fence look, bushes look, vegetation look, tree trunk look, etc.). The information/picture on each side of the pole skin can be the same or different.

Referring now to FIG. 19, there is illustrated an arrangement to inflate an inflatable structure. For example, inflatable structure 750 can be an inflatable pole cover. Inflatable structure 750 is illustrated as having a hole and/or aperture 760 extending at least partially therethrough, and as having a valve and/or cap 759 designed to facilitate inflation and/or deflation of said inflatable structure 750. As further illustrated in FIG. 19, an air pump 752, such as, for example, an electric air pump can be used to inflate inflatable structure 750; however, this is not required. A hose 754 can be connected at a first end to air outlet 756 of air pump 752 and connected at a second end to valve and/or cap 758 of inflatable structure 750. Thus, when the air pump 752 is switched on, air can be pumped through hose 754 in the direction of arrow A and fill the internal cavity of inflatable structure 750.

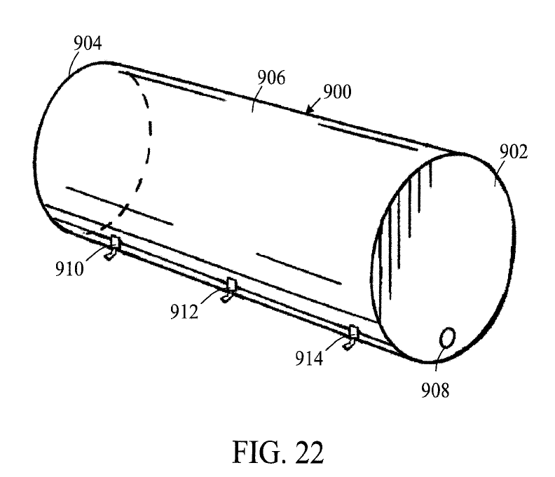

Referring now to FIG. 22, there is illustrated an inflatable filler 900 in accordance with another and/or alternative non-limiting aspect of the present invention. Inflatable filler 900 is illustrated as being generally cylindrical and as having a circular cross-sectional shape; however, this is not required. As can be appreciated, the inflatable filler can have other or alternative cross-sectional shapes (e.g., square, oval, trapezoid, polygonal, etc.). As illustrated in FIG. 22, inflatable filler 900 is formed of at least one panel, including a first end panel 902, a second end panel 904, and a body panel 906. End panel 902 is illustrated as including a valve and/or cap 908 in and/or covering an opening in the end panel for the purpose of facilitating inflation and/or deflation of inflatable filler 900; however, valve and/or cap 908 can be provided at other or alternative panels of the inflatable filler 900. The first end panel 902, second end panel, 904, and/or body panel 906 can include printed material (e.g., advertisement, numbers, information by obstacle, etc.) and/or pictures (e.g., brick face look, stacked log look, wood panel look, stone face look, fence look, bushes look, vegetation look, tree trunk look, etc.).

With continued reference to FIG. 22, inflatable filler 900 also includes a plurality of connection arrangements, 910, 912, 914. Connection arrangements 910, 912, 914 are illustrated as being spaced apart and connected along the body panel 906. Generally connection arrangements 910, 912, 914 are designed to facilitate attachment of inflatable filler 900 to the ground, other inflatable structures, ground poles, etc. In one non-limiting configuration, the connection arrangements 910, 912, 914 can be used to temporarily connect one or more inflatable fillers 900 together so as to build a temporary inflatable horse jump; however, this is not required. As can be appreciated, inflatable filler 900 can be used as 1) a filler (i.e. positionable between a first and second standard, inflatable standard, etc.), and/or 2) a standard (i.e. positionable at or near an end of a filler, inflatable filler, pole, etc.) and is thus interchangeable. One non-limiting advantage of providing such an interchangeable filler/standard structure is that the versatility of the inflatable horse jump equipment can be increased. As can be appreciated, inflatable filler 900 can be used singularly as an inflatable horse jump; however, this is not required.

As can be appreciated, inflatable filler 900 can include other or additional features, such as, for example a handle (see FIG. 1), an emergency air release zipper (see FIG. 1), one or more weight structures (see FIGS. 1-2), one or more inflatable support structures permanently or releasably connected to a panel of the inflatable filler (see FIG. 2), one or more water bladders (see FIG. 3), a removable cover (see FIG. 9), one or more connection arrangements (see FIG. 4), etc.

As can be appreciate with any of the inflatable structures described above, the exterior surface can include printing that can include advertising, numbers, information about the inflatable structure, certain color or color patterns, and/or a graphic picture (e.g., brick face look, stacked log look, wood panel look, stone face look, fence look, bushes look, vegetation look, tree trunk look, etc.).

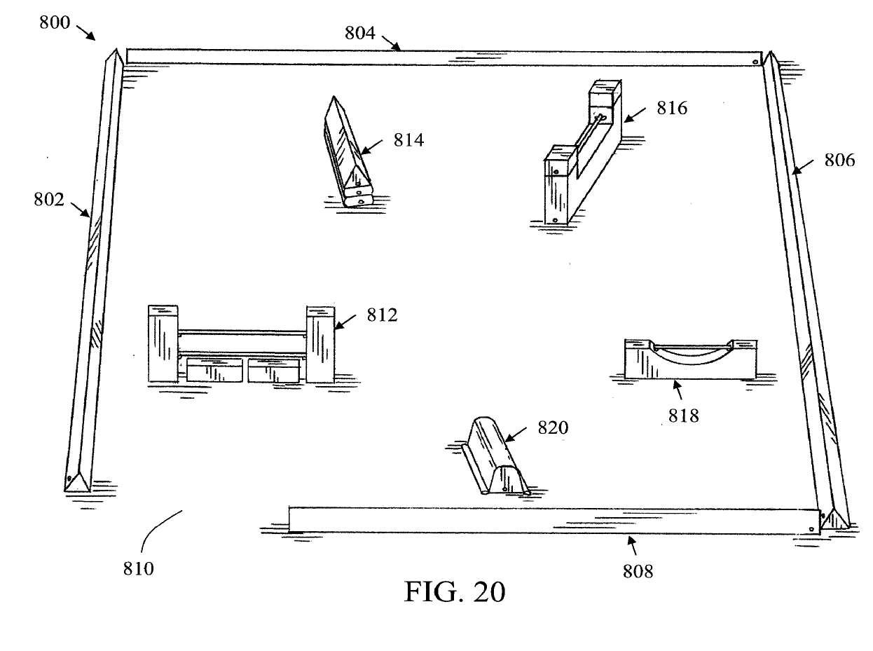

Referring now to FIG. 20, there is illustrated a top view of one non-limiting obstacle course 800 that can be created with the inflatable structures in accordance with the present invention. The obstacle course includes various inflatable horse course equipment components. Obstacle course 800 is illustrated as having a boundary defined by inflatable arena borders 802, 804, 806, 808. The size and shape of the inflatable arena borders 802, 804, 806, 808 are non-limiting. As illustrated in FIG. 20, the inflatable arena borders can be sized so as to provide an entrance 810 into obstacle course 800. The entrance is illustrated as being absent an inflatable arena border.

Obstacle course 800 can include various inflatable horse course equipment components that are spaced from one another to form a desired obstacle course within the boundaries of the inflatable arena borders. As illustrated in FIG. 20, the non-limiting obstacle course includes an inflatable horse jump 812 (similar in structure and function to inflatable horse jump 500 of FIG. 10), an inflatable cone top 814 (similar in structure and function to inflatable cone top 380 of FIG. 8), an inflatable square end horse jump 816 (similar in structure and function to inflatable square end horse jump 200 in FIG. 5), an inflatable bowl cut horse jump 818 (similar in structure and function to inflatable bowl cut horse jump 280 of FIG. 6, and an inflatable roll top 820 (similar in structure and function to inflatable roll top 10 of FIG. 1); however, this is not required. As can be appreciated any combination of various horse course equipment components as described in accordance with the present invention above can be used as part of obstacle course 800; however, this is not required. One or more of the inflatable structures can be secured in place as described above.

As can be appreciated, any inflatable horse course equipment component used in obstacle course 800 can include other or additional features, such as, for example, a handle (see FIG. 1), an emergency air release zipper (see FIG. 1), at least one connection arrangement (see FIGS. 1-10), at least one loop structure (see FIG. 10), a removeable cover, one or more weight structures, etc.

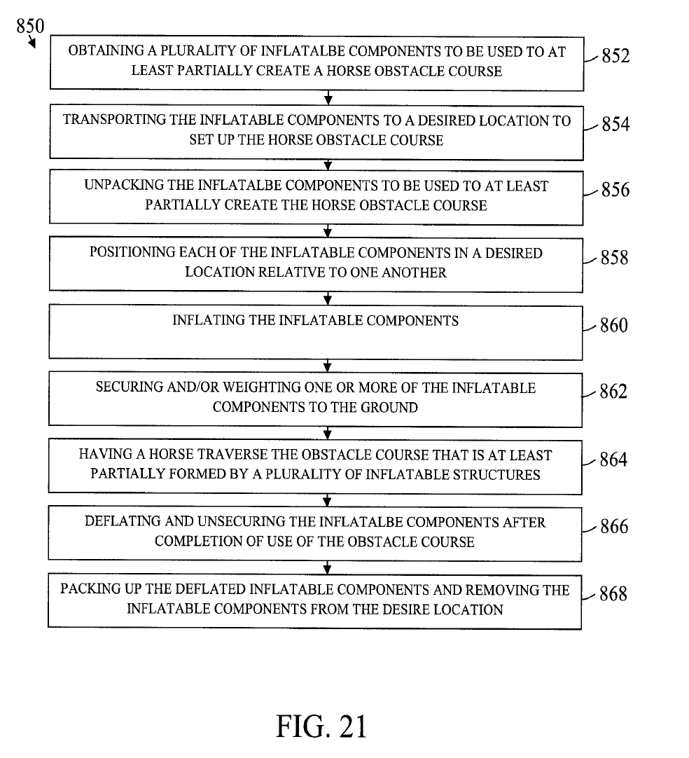

Referring now to FIG. 21, there is illustrated a non-limiting method 850 for assembling, using, and disassembling a horse obstacle in accordance with the present invention. The method can comprise the steps of:

1) Obtaining a plurality of inflatable components that are to be used to at least partially create a horse obstacle course (Step 852). The inflatable components can be the same or different in size and/or shape. The number and type of inflatable components should be selected so the desired obstacle course can be created.

2) After the plurality of inflatable components are obtained, the inflatable components are then transported to a desired location for the horse obstacle course (Step 854). The method of transporting the plurality of inflatable components is non-limiting (e.g., manually carried car, truck, trailer, cart, etc.). During the transport of the inflatable components, the inflatable components in a partially or fully deflated stated can be optionally packaged in one or more bags for ease of transport. A bag can include one or more components. The bag can be labeled and/or size to container and/or indicate the inflatable structure(s) in the bag.

3) After the plurality of inflatable components are transported to a desired location for the horse obstacle course, the plurality of inflatable components are optionally unpacked (if packed during transport) (Step 856). Such unpacking can include removing the inflatable component from the transport vehicle and/or unpacking the inflatable component from a bag, crate, box, container, etc.

4) The one or more inflatable components, once at the desired location, are then moved to a desired position at the desired location (Step 858). Generally, the obstacle course includes a plurality of obstacles that are spaced apart from one another and which are arranged in a certain order. The inflatable components are thus moved to such locations. Generally, the inflatable components are moved to such location prior to being fully inflated; however, this is not required.

5) Once an inflatable component is at its desired location on the obstacle course, the inflatable component can be inflated, if not already inflated (Step 860). The inflation is generally accomplished by one or more electric or gas blowers; however, manual pumps can be used.

6) Prior to, during and/or after the inflation of the inflatable component, the inflatable component can be optionally secured to the ground, and/or one or more weight structures on the inflatable component can be partially or fully filled with a weighting material to facilitate in maintaining the inflatable component in a desired position on the obstacle course (Step 862).

7) Once the obstacle course has been set up, such as, for example, the non-limiting obstacle course as illustrated in FIG. 20, the obstacle course can be used by a horse rider to traverse one or more of the obstacles (Step 864). Generally, the obstacle course includes a plurality of obstacles that are partially or fully formed of one or more inflatable components. Generally, the obstacles are different; however, this is not required. The number of obstacles and the number of different obstacle that can be used to form the obstacle course is non-limiting. As illustrated in FIG. 20, the obstacle course perimeter can be defined by one or more inflatable arena borders. The perimeter of the obstacle course illustrated in FIG. 20 is illustrated as being generally square or rectangular; however, it can be appreciated that any shaped obstacle course perimeter can be set up by use of the inflatable arena borders. The spacing of the obstacles and the order of arrangement of the obstacles on the obstacle is non-limiting. As can be appreciated, the obstacle course can be set up to simulate an obstacle course that is to be used in a later or former competition so that the rider can train the horse for future competitions; however, this is not required. Since the obstacle course is designed as a training course (however, it could be used as a course in actual competitions), the inflatable structures are designed to reduce incidence of injury to the rider and/or horse during the riding of the obstacle course. Since the obstacles are partially or fully formed of inflatable components, the weight of the obstacles is significantly less than that of traditional obstacles that are used in obstacle courses for horses. As such, the setup and movement of the obstacles that are formed of one or more inflatable components is generally much easier, simpler, and safer, and generally requires less time and personnel to setup.

8) Once the use of the obstacle course is completed, the plurality of inflatable components are partially or fully deflated (Step 866). If any of the inflatable components were secured to the ground, the inflatable components are generally unsecured from the ground. If any weighted material was added to the inflatable components, some or all of the weighted material can be optionally removed from the inflatable component.

9) After the plurality of inflatable components are partially or fully deflated, the inflatable components are packed up so as to be transported from the site of the obstacle course (Step 868). The inflatable components can be optionally packed in bags, containers, crates, and the like for ease of transport and/or storage.

The invention has been described with reference to the preferred embodiment and alternatives thereof. It is believed that many modifications and alterations to the embodiment disclosed will readily suggest themselves to those skilled in the art upon reading and understanding the detailed description of the invention. It is intended to include all such modifications and alterations insofar as they come within the scope of the present invention.

1. A method for training an animal for a sport on an obstacle course comprising:
a. obtaining a plurality of inflatable components that are to be used to at least partially create said obstacle course for said animal;
b. transporting said plurality of inflatable components to a desired location for said obstacle course;
c. moving said plurality of inflatable components to a desired position at said desired location for said obstacle course;
d. inflating said plurality of inflatable components to form a plurality of inflatable obstacles, each of said a plurality of said inflatable obstacles including at least one of said inflatable components, said inflatable obstacles partially or fully formed from one or more of said inflatable components:
e. arranging said plurality of inflatable obstacles on said desired location to at least partially form said obstacle course, a plurality of said inflatable obstacles are spaced from one another on said obstacle course;
f. having an animal move through and traverse said obstacle course to train said animal on said obstacle course for said animal;
g. partially or fully deflating a plurality of said inflatable components after training of said animal on said obstacle course is completed; and,
h. transporting said partially or fully deflating said inflatable components away from said desired location for said obstacle course.

2. The method as defined in claim 1, wherein said plurality of inflatable components are used to form a plurality of said obstacles having a different shape, one or more of said obstacles forming a jumping obstacle for said animal that are selected from the group consisting of an inflatable roll top, an inflatable horseshoe top, an inflatable square end animal jump, an inflatable bowl cut animal jump, an inflatable V-cut animal jump, an inflatable cone top, an inflatable cover, inflatable fillers, an inflatable round top animal jump, an inflatable animal jump, and an inflatable arena border.

3. The method as defined in claim 1, wherein a plurality of said inflatable components that are transported to said desired location for said obstacle course are folded and packaged in a bag or container during said step of transport, and said plurality of said inflatable components are removed from said bag or container and unfolded at said desired location for said obstacle course.

4. (canceled)

5. The method as defined in claim 1, wherein said step of inflation includes using an electric or gas blower to at least partially inflate a plurality of said inflatable components.

6. (canceled)

7. The method as defined in claim 1, including the step of securing to the ground or weighting to the ground using a weight structure on one or more of said inflatable components to facilitate in maintaining at least one of said obstacles in a desired position on said obstacle course.

8. (canceled)

9. The method as defined in claim 1, further including the steps of i) providing a plurality of inflatable arena borders, ii) inflating said plurality of inflatable arena borders, iii) at least partially forming an outer perimeter for said obstacle course by positioning said plurality of inflatable arena borders about said outer perimeter.

10. (canceled)

11. The method as defined in claim 2, wherein said obstacle that is formed of at least one of said inflatable components includes said inflatable roll top, said inflatable roll top includes a base panel, a first side panel, a second side panel, and a top panel, said first and second side panels having a generally trapezoidal shape and having a top portion that is curved or rounded, said inflatable roll top having a cavity, over 50% of said inflatable roll top formed of a material that is durable, flexible, bendable, and foldable, and which material is partially or fully impermeable to air, said inflatable roll top configured to withstand impact forces of at least 200 pounds without causing damage to said inflatable roll top when in a fully inflated state, said inflatable roll top including a valve or cap to control or prevent air flow into said cavity, out of said cavity, or combinations thereof.

12. (canceled)

13. The method as defined in claim 11, wherein said inflatable roll top includes a first weight structure, a connection arrangement, or combinations thereof used to maintain said inflatable roll top in position when contacted by said animal, inhibit tipping of said inflatable roll top when contacted by said animal, or combinations thereof.

14. (canceled)

15. The method as defined in claim 2, wherein said obstacle that is formed of at least one of said inflatable components includes said inflatable horseshoe top, said inflatable horseshoe top includes an inflatable base structure, a first inflatable top structure, and a second inflatable top structure, said first and second inflatable top structures having an arcuate shape and extending upwardly from said inflatable base structure, said first and second inflatable top structures spaced from one another to enable a animal to jump between said first and second inflatable top structures, said inflatable horseshoe top having a cavity, over 50% of said inflatable horseshoe top formed of a material that is durable, flexible, bendable, and foldable, and which material is partially or fully impermeable to air, said inflatable horseshoe top configured to withstand impact forces of at least 200 pounds without causing damage to said inflatable horseshoe top when in a fully inflated state, said inflatable horseshoe top including a valve or cap to control or prevent air flow into said cavity, out of said cavity, of combinations thereof.

16. (canceled)

17. The method as defined in claim 15, wherein said inflatable horseshoe top includes a first weight structure, a connection arrangement, or combinations thereof used to maintain said inflatable horseshoe top in position when contacted by said animal, inhibit tipping of said inflatable horseshoe top when contacted by said horse animal, or combinations thereof.

18. (canceled)

19. The method as defined in claim 2, wherein said obstacle that is formed of at least one of said inflatable components includes said inflatable square end animal jump, said inflatable square end animal jump includes an inflatable base portion, first and second cups and a pole that is configured to be supported by said first and second cups, said inflatable square end animal jump having a cavity, over 50% of said inflatable square end animal jump formed of a material that is durable, flexible, bendable, and foldable, and which material is partially or fully impermeable to air, said inflatable square end animal jump configured to withstand impact forces of at least 200 pounds without causing damage to said inflatable square end animal jump when in a fully inflated state, said inflatable square end animal jump including a valve or cap to control or prevent air flow into said cavity, out of said cavity, or combinations thereof.

20. (canceled)

21. The method as defined in claim 19, wherein said inflatable square end animal jump includes a first weight structure, a connection arrangement, or combinations thereof used to maintain said inflatable square end animal jump in position when contacted by said animal inhibit tipping of said inflatable square end animal jump when contacted by said animal, or combinations thereof.

22. (canceled)

23. The method as defined in claim 2, wherein said obstacle that is formed of at least one of said inflatable components includes said inflatable bowl cut animal jump, said inflatable bowl cut animal jump includes an inflatable base portion, first and second cups and a pole that is configured to be supported by said first and second cups, said inflatable bowl cut animal jump having a cavity, over 50% of said inflatable bowl cut animal jump formed of a material that is durable, flexible, bendable, and foldable, and which material is partially or fully impermeable to air, said inflatable bowl cut animal jump configured to withstand impact forces of at least 200 pounds without causing damage to said inflatable bowl cut animal jump when in a fully inflated state, said inflatable bowl cut animal jump including a valve or cap to control or prevent air flow into said cavity, out of said cavity, or combinations thereof.

24. (canceled)

25. The method as defined in claim 23, wherein said inflatable bowl cut animal jump includes a first weight structure, a connection arrangement, or combinations thereof used to maintain said inflatable bowl cut animal jump in position when contacted by said animal, inhibit tipping of said inflatable bowl cut animal jump when contacted by said animal, or combinations thereof.

26. (canceled)

27. The method as defined in claim 2, wherein said obstacle that is formed of at least one of said inflatable components includes said inflatable V-cut animal jump, said inflatable V-cut animal jump includes an inflatable base portion, first and second cups and a pole that is configured to be supported by said first and second cups, said inflatable V-cut animal jump having a cavity, over 50% of said inflatable V-cut animal jump formed of a material that is durable, flexible, bendable, and foldable, and which material is partially or fully impermeable to air, said inflatable V-cut animal jump configured to withstand impact forces of at least 200 pounds without causing damage to said inflatable V-cut animal jump when in a fully inflated state, said inflatable V-cut animal jump including a valve or cap to control or prevent air flow into said cavity, out of said cavity, or combinations thereof.

28. (canceled)

29. The method as defined in claim 27, wherein said inflatable V-cut animal jump includes a first weight structure, a connection arrangement, or combinations thereof used to maintain said inflatable V-cut animal jump in position when contacted by said animal, inhibit tipping of said inflatable V-cut animal jump when contacted by said animal, or combinations thereof.

30. (canceled)

31. The method as defined in claim 2, wherein said obstacle that is formed of at least one of said inflatable components includes said inflatable cone top, said inflatable cone top having a triangular cross-sectional shape, said inflatable cone top having a cavity, over 50% of said inflatable cone top formed of a material that is durable, flexible, bendable, and foldable, and which material is partially or fully impermeable to air, said inflatable cone top configured to withstand impact forces of at least 200 pounds without causing damage to said inflatable cone top when in a fully inflated state, said inflatable cone top including a valve or cap to control or prevent air flow into said cavity, out of said cavity, or combinations thereof.

32. (canceled)

33. The method as defined in claim 31, wherein said inflatable cone top includes a first weight structure, a connection arrangement, or combinations thereof used to maintain said inflatable cone top in position when contacted by said animal, inhibit tipping of said inflatable cone top when contacted by said animal, or combinations thereof.

34. (canceled)

35. The method as defined in claim 2, wherein said obstacle that is formed of at least one of said inflatable components includes said inflatable round top animal jump, said inflatable round top animal jump includes an inflatable base portion, first and second cups and a pole that is configured to be supported by said first and second cups, said inflatable round top animal jump having a cavity, over 50% of said inflatable round top animal jump formed of a material that is durable, flexible, bendable, and foldable, and which material is partially or fully impermeable to air, said inflatable round top animal jump configured to withstand impact forces of at least 200 pounds without causing damage to said inflatable round top animal jump when in a fully inflated state, said inflatable round top animal jump including a valve or cap to control or prevent air flow into said cavity, out of said cavity, or combinations thereof.

36. (canceled)

37. The method as defined in claim 35, wherein said inflatable round top animal jump includes a first weight structure, a connection arrangement, or combinations thereof used to maintain said inflatable round top animal jump in position when contacted by said animal, inhibit tipping of said inflatable round top animal jump when contacted by said animal, or combinations thereof.

38. (canceled)

39. The method as defined in claim 2, wherein said obstacle that is formed of at least one of said inflatable components includes said inflatable animal jump, said inflatable animal jump includes a first standard and a second standard that are spaced from another, first and second cups on each of said first and second standards, and first and second poles wherein said first pole is configured to be supported by said first cups on said first and second standards and said second pole is configured to be supported by said second cups on said first and second standards, said inflatable animal jump having a cavity, over 50% of said inflatable animal jump formed of a material that is durable, flexible, bendable, and foldable, and which material is partially or fully impermeable to air, said inflatable animal jump configured to withstand impact forces of at least 200 pounds without causing damage to said inflatable animal jump when in a fully inflated state, said inflatable animal jump including a valve or cap to control or prevent air flow into said cavity, out of said cavity, or combinations thereof.

40. (canceled)

41. The method as defined in claim 39, wherein said inflatable animal jump includes a first weight structure, a connection arrangement, or combinations thereof used to maintain said inflatable animal jump in position when contacted by said animal, inhibit tipping of said inflatable animal jump when contacted by said animal, or combinations thereof.

42. (canceled)

43. The method as defined in claim 39, wherein a pole skin is connected to said first and second poles, said pole skin including first and second connection arrangements, said first connection arrangement configured to be connected to said first pole, said second connection arrangement configured to be connected to said second pole, said pole skin including a flexible panel positioned between said first and second connection arrangements and is configured to at least partially cover a gap between said first and second pole when said first and second poles are supported by said cups.

44. (canceled)

45. The method as defined in claim 2, wherein said obstacle that is formed of at least one of said inflatable components includes said inflatable arena border, said inflatable arena border includes an inflatable base portion, said inflatable arena border having a cavity, over 50% of said inflatable arena border formed of a material that is durable, flexible, bendable, and foldable, and which material is partially or fully impermeable to air, said inflatable arena border configured to withstand impact forces of at least 200 pounds without causing damage to said inflatable arena border when in a fully inflated state, said inflatable arena border including a valve or cap to control or prevent air flow into said cavity, out of said cavity, or combinations thereof.

46. (canceled)

47. The method as defined in claim 45, wherein said inflatable arena border includes a first weight structure, a connection arrangement, or combinations thereof used to maintain said inflatable arena border in position when contacted by said animal, inhibit tipping of said inflatable arena border when contacted by said animal, or combinations thereof.

48. (canceled)

49. The method as defined in claim 2, wherein said obstacle is a animal jump that includes a first standard, a second standard, a cup positioned on each of said first and second standards, a pole that is configured to be supported by said cups on said first and second standards, and an inflatable pole cover that covers at least 60% the length of said pole, said inflatable pole cover includes a body panel, a first end panel, a second end panel, a cavity, and an aperture that passes through a longitudinal length of said inflatable pole cover when said inflatable pole cover is fully inflated, over 50% of said inflatable pole cover formed of a material that is durable, flexible, bendable, and foldable, and which material is partially or fully impermeable to air, said inflatable pole cover configured to withstand impact forces of at least 200 pounds without causing damage to said inflatable pole cover when in a fully inflated state, said inflatable pole cover including a valve or cap to control or prevent air flow into said cavity, out of said cavity, or combinations thereof.

50. (canceled)

51. The method as defined in claim 49, wherein said inflatable pole cover includes a connection arrangement used to connect to another inflatable pole cover.

52. The method as defined in claim 49, wherein said inflatable pole cover includes a connector that connects to multiple surfaces of said inflatable pole cover to maintain a desired shape of said inflatable pole cover when said inflatable pole cover is fully inflated.

53. A method for training an animal for a sport on an obstacle course comprising:
a. obtaining a plurality of inflatable components that are to be used to at least partially create said obstacle course for said animal;
b. transporting said plurality of inflatable components to a desired location for said obstacle course;
c. moving said plurality of inflatable components to a desired position at said desired location for said obstacle course;
d. inflating said plurality of inflatable components to form a plurality of inflatable obstacles, each of said plurality of said inflatable obstacles including at least one of said inflatable components, said inflatable obstacles partially or fully formed from one or more of said inflatable components, said plurality of inflatable components used to form a plurality of said obstacles having a different shape, one or more of said obstacles forming a jumping obstacle for said animal that are selected from the group consisting of an inflatable roll top, an inflatable horseshoe top, an inflatable square end animal jump, an inflatable bowl cut animal jump, an inflatable V-cut animal jump, an inflatable cone top, an inflatable cover, inflatable fillers, an inflatable round top animal jump, an inflatable animal jump, and an inflatable arena border,
e. arranging said plurality of inflatable obstacles on said desired location to at least partially form said obstacle course, a plurality of said inflatable obstacles are spaced from one another on said obstacle course;
f. having an animal move through and traverse said obstacle course to train said animal on said obstacle course for said animal;
g. partially or fully deflating a plurality of said inflatable components after training of said animal on said obstacle course is completed; and,
h. transporting said partially or fully deflating said inflatable components away from said desired location for said obstacle course.

54. The method as defined in claim 53, wherein said obstacle that is formed of at least one of said inflatable components includes A) said inflatable roll top, said inflatable roll top includes a base panel, a first side panel, a second side panel, and a top panel, said first and second side panels having a generally trapezoidal shape and having a top portion that is curved or rounded, said inflatable roll top having a cavity, over 50% of said inflatable roll top formed of a material that is durable, flexible, bendable, and foldable, and which material is partially or fully impermeable to air, said inflatable roll top configured to withstand impact forces of at least 200 pounds without causing damage to said inflatable roll top when in a fully inflated state, said inflatable roll top including a valve or cap to control or prevent air flow into said cavity, out of said cavity, or combinations thereof, B) said inflatable horseshoe top, said inflatable horseshoe top includes an inflatable base structure, a first inflatable top structure, and a second inflatable top structure, said first and second inflatable top structures having an arcuate shape and extending upwardly from said inflatable base structure, said first and second inflatable top structures spaced from one another to enable an animal to jump between said first and second inflatable top structures, said inflatable horseshoe top having a cavity, over 50% of said inflatable horseshoe top formed of a material that is durable, flexible, bendable, and foldable, and which material is partially or fully impermeable to air, said inflatable horseshoe top configured to withstand impact forces of at least 200 pounds without causing damage to said inflatable horseshoe top when in a fully inflated state, said inflatable horseshoe top including a valve or cap to control or prevent air flow into said cavity, out of said cavity, of combinations thereof, C) said inflatable square end animal jump, said inflatable square end animal jump includes an inflatable base portion, first and second cups and a pole that is configured to be supported by said first and second cups, said inflatable square end animal jump having a cavity, over 50% of said inflatable square end animal jump formed of a material that is durable, flexible, bendable, and foldable, and which material is partially or fully impermeable to air, said inflatable square end animal jump configured to withstand impact forces of at least 200 pounds without causing damage to said inflatable square end animal jump when in a fully inflated state, said inflatable square end animal jump including a valve or cap to control or prevent air flow into said cavity, out of said cavity, or combinations thereof, D) said inflatable bowl cut animal jump, said inflatable bowl cut animal jump includes an inflatable base portion, first and second cups and a pole that is configured to be supported by said first and second cups, said inflatable bowl cut animal jump having a cavity, over 50% of said inflatable bowl cut animal jump formed of a material that is durable, flexible, bendable, and foldable, and which material is partially or fully impermeable to air, said inflatable bowl cut animal jump configured to withstand impact forces of at least 200 pounds without causing damage to said inflatable bowl cut animal jump when in a fully inflated state, said inflatable bowl cut animal jump including a valve or cap to control or prevent air flow into said cavity, out of said cavity, or combinations thereof, E) said inflatable V-cut animal jump, said inflatable V-cut animal jump includes an inflatable base portion, first and second cups and a pole that is configured to be supported by said first and second cups, said inflatable V-cut animal jump having a cavity, over 50% of said inflatable V-cut animal jump formed of a material that is durable, flexible, bendable, and foldable, and which material is partially or fully impermeable to air, said inflatable V-cut animal jump configured to withstand impact forces of at least 200 pounds without causing damage to said inflatable V-cut animal jump when in a fully inflated state, said inflatable V-cut animal jump including a valve or cap to control or prevent air flow into said cavity, out of said cavity, or combinations thereof, F) said inflatable cone top, said inflatable cone top having a triangular cross-sectional shape, said inflatable cone top having a cavity, over 50% of said inflatable cone top formed of a material that is durable, flexible, bendable, and foldable, and which material is partially or fully impermeable to air, said inflatable cone top configured to withstand impact forces of at least 200 pounds without causing damage to said inflatable cone top when in a fully inflated state, said inflatable cone top including a valve or cap to control or prevent air flow into said cavity, out of said cavity, or combinations thereof, G) said inflatable round top animal jump, said inflatable round top animal jump includes an inflatable base portion, first and second cups and a pole that is configured to be supported by said first and second cups, said inflatable round top animal jump having a cavity, over 50% of said inflatable round top animal jump formed of a material that is durable, flexible, bendable, and foldable, and which material is partially or fully impermeable to air, said inflatable round top animal jump configured to withstand impact forces of at least 200 pounds without causing damage to said inflatable round top animal jump when in a fully inflated state, said inflatable round top animal jump including a valve or cap to control or prevent air flow into said cavity, out of said cavity, or combinations thereof, H) said inflatable animal jump, said inflatable animal jump includes a first standard and a second standard that are spaced from another, first and second cups on each of said first and second standards, and first and second poles wherein said first pole is configured to be supported by said first cups on said first and second standards and said second pole is configured to be supported by said second cups on said first and second standards, said inflatable animal jump having a cavity, over 50% of said inflatable animal jump formed of a material that is durable, flexible, bendable, and foldable, and which material is partially or fully impermeable to air, said inflatable animal jump configured to withstand impact forces of at least 200 pounds without causing damage to said inflatable animal jump when in a fully inflated state, said inflatable animal jump including a valve or cap to control or prevent air flow into said cavity, out of said cavity, or combinations thereof, I) said inflatable arena border, said inflatable arena border includes an inflatable base portion, said inflatable arena border having a cavity, over 50% of said inflatable arena border formed of a material that is durable, flexible, bendable, and foldable, and which material is partially or fully impermeable to air, said inflatable arena border configured to withstand impact forces of at least 200 pounds without causing damage to said inflatable arena border when in a fully inflated state, said inflatable arena border including a valve or cap to control or prevent air flow into said cavity, out of said cavity, or combinations thereof, and J) an animal jump that includes a first standard, a second standard, a cup positioned on each of said first and second standards, a pole that is configured to be supported by said cups on said first and second standards, and an inflatable pole cover that covers at least 60% the length of said pole, said inflatable pole cover includes a body panel, a first end panel, a second end panel, a cavity, and an aperture that passes through a longitudinal length of said inflatable pole cover when said inflatable pole cover is fully inflated, over 50% of said inflatable pole cover formed of a material that is durable, flexible, bendable, and foldable, and which material is partially or fully impermeable to air, said inflatable pole cover configured to withstand impact forces of at least 200 pounds without causing damage to said inflatable pole cover when in a fully inflated state, said inflatable pole cover including a valve or cap to control or prevent air flow into said cavity, out of said cavity, or combinations thereof.

55. The method as defined in claim 54, further including the steps of i) providing a plurality of inflatable arena borders, ii) inflating said plurality of inflatable arena borders, iii) at least partially forming an outer perimeter for said obstacle course by positioning said plurality of inflatable arena borders about said outer perimeter.
